(19) United States
(12) Patent Application Publication
(10) Pub. No.: US 2008/0081011 A1
(43) Pub. Date: Apr. 3, 2008

(54) Oxynitride Phosphor and Light-Emitting Device

(75) Inventor: Shozo Oshio, Osaka (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi, Osaka (JP)

(21) Appl. No.: 11/720,040

(22) PCT Filed: Dec. 28, 2005
(86) PCT No.: PCT/JP05/24281

§ 371 Date: May 23, 2007

(30) Foreign Application Priority Data
Jan. 6, 2005 (JP) 2005-001800
Sep. 22, 2005 (JP) 2005-276375

(51) Int. Cl. C01F 17/00; C01B 33/26

(52) U.S. Cl. 423/263; 423/327.1

(57) ABSTRACT

An oxynitride phosphor containing a luminescent center ion in a crystal lattice of an oxynitride is used, in which the oxynitride is a compound represented by a chemical formula: M₂Si₅₋ₚAlₚOₚN₈₋ₚ, where M is at least one element selected from the group consisting of Mg, Ca, Sr, Ba, and Zn, and p is a numerical value satisfying an expression: 0<p<1. Furthermore, a light-emitting device is formed using a phosphor (2) containing the oxynitride phosphor and a light-emitting element (1) exciting the phosphor (2). Owing to this, there are provided a novel oxynitride phosphor having satisfactory emission characteristics and high emission performance, in particular, an oxynitride phosphor satisfying both high emission efficiency and satisfactory temperature characteristics and emitting red light suitable for industrial production, and a light emitting device using the phosphor.

### TECHNICAL FIELD

The present invention relates to an oxynitride phosphor and a light-emitting device using the phosphor.

### BACKGROUND ART

Recently, requests for a phosphor and a light-emitting device using the phosphor have been diversified, and in particular, the development of a novel red phosphor and a light-emitting device emitting light of a warm color, using the red phosphor, has been expected.

Furthermore, in the field of developing a light-emitting diode light source emitting white light using a phosphor (white LED), the input power is increasing year after year in order to increase output. Therefore, there also is a light source in which a light-emitting element that is an excitation source of a phosphor generates heat at about 100° C. to 180° C. Most of such white LED light sources need to excite a phosphor at the same temperature as that of the light-emitting element due to the configuration, so that there is a demand for a phosphor exhibiting high emission performance even at a temperature equal to or higher than 100° C.

Conventionally, as a nitride phosphor and an oxynitride phosphor, those shown in the following (1) to (4) are known. These phosphors are excited with ultraviolet to blue light, and emit red light having an emission peak in a wavelength range of 610 nm to less than 660 nm. Therefore, it is known that these phosphors preferably are used for a light-emitting device such as a white LED light source, for example.

(1) M₂Si₅N₈:Eu²⁺ (M represents at least one element selected from Ca, Sr, Ba, and Zn (see the following Document 1)

(2) Sr₂Si₄AlON₇:Eu²⁺ (see the following Document 2)

(3) CaSi₆AlON₉:Eu²⁺ (see the following Document 2)

(4) CaAlSiN₃:Eu²⁺ (see the following Document 6)

As the above-mentioned M₂Si₅N₈:Eu²⁺ nitride phosphor, a nitride phosphor is known, which contains a trace amount of aluminum of the order of several 10 to 1000 ppm and a trace amount of oxygen of several % or less as an impurity for the purpose of enhancing an emission intensity and afterglow characteristics (see the following Document 3).

Furthermore, as a M₂Si₅N₈:Ce³⁺ nitride phosphor containing Ce³⁺ as a required luminescent center ion, a MₓSi_{y}AlᵤO_{z}N_{((2/3)x+(4/3)y+u-(2/3)z)}:Ce³⁺ oxynitride phosphor similarly is known, in which the composition of the nitride phosphor is fine-adjusted for the purpose of enhancing an emission intensity (see the following Document 4). M represents at least one element selected from Mg, Ca, Sr, Ba, and Zn, and x, y, u, z respectively represent numerical values satisfying Expressions: 1.5<x<2.5, 4.5<y<5.5, 0<u<0.5<0≦z<1,or Expressions: 0.5<x<1.5, 6.5<y<7.5, 0<u<0.5, 0≦z<1.

Furthermore, for the purpose of obtaining green to yellow emission as a result of excitation with light in an ultraviolet to visible light region, the composition of an oxynitride phosphor containing Eu²⁺ as a luminescent center ion, and containing an alkaline-earth metal element, silicon, aluminum, oxygen, and nitrogen as main constituent elements has been studied. Consequently, a M_{X}Si_{Y}Al_{U}O_{Z}N_{((2/3)X+(4/3)Y+U-(2/3)Z)}:Eu²⁺ oxynitride phosphor has been proposed (see the following Reference 5), where M represents at least one element selected from Mg, Ca, Sr, Ba, and Zn; X, Y, U, Z respectively represent numerical values satisfying Expressions: 0.5<x<1.5, 1.5<y<2.5, 0<U<0.5, 1.5<z<2.5.

Regarding the above-mentioned conventionally known nitride M₂Si₅N₈, the following is known: the crystal structure varies depending upon the kind of M; and for example, in the case where the main component of M is Ca, the nitride M₂Si₅N₈ has a monoclinic crystal structure, while in the case where the main component of M is Sr or Ba, the nitride M₂Si₅N₈ has an orthorhombic crystal structure (see the following Documents 7 and 8). It also is known that owing to the satisfactory temperature characteristics, the nitride M₂Si₅N₈ is hardly subjected to temperature extinction, and holds an emission intensity at a similar level to that at room temperature, even when the temperature of the phosphor increases to about 100° C. On the other hand, regarding the conventionally known oxynitride phosphor (e.g., Sr₂Si₄AlON₇:Eu²⁺), the crystal structure and temperature characteristics are not known.

Conventionally, as a phosphor for a white LED light source, a phosphor composition containing a luminescent center ion in a crystal lattice and being represented by a general formula: M₂Si₅₋ₚAlₚOₚN₈₋ₚ has been studied (see the following Document 9). In this formula, M is at least one element selected from Mg, Ca, Sr, Ba, and Zn, and p is a numerical value satisfying 0<p<5.

Document 9 describes that it is apparent that a compound in a single crystal phase satisfying p=2, i.e., a compound represented by a chemical formula: M₂Si₃Al₂O₂N₆ actually exists and can be produced. However, regarding a compound in which p is a numerical value other than 2, above all, a compound in a single crystal phase in which p is a numerical value satisfying 0<p<1, i.e., a compound represented by a chemical formula: M₂Si₅₋ₚAlₚOₚN₈₋ₚ (M is at least one element selected from Mg, Ca, Sr, Ba, and Zn, and p is a numerical value satisfying 0<p<1), Document 9 does not describe clearly the actual existence of a compound in a single crystal phase, and does not describe that it is apparent that such a compound can be produced.

According to the experiment of the inventors, in a composition represented by the above general formula: M₂Si₅₋ₚAlₚOₚN₈₋ₚ, at least in a numerical value range where p satisfies 2<p<5, the existence of a compound in a single crystal phase, i.e., a compound represented by a chemical formula: M₂Si₅₋ₚAlₚOₚN₈₋ₚ is not recognized.

(Document 1) JP 2003-515665 A

(Document 2) JP 2003-206481 A

(Document 3) JP 2003-321675 A

(Document 4) JP 2004-244560 A

(Document 5) JP 2004-277547 A

(Document 6) “Extended Abstracts (65th Meeting, 2004) Japan Society of Applied Physics” (No. 3, p. 1283) by N. Hirosaki et al.

(Document 7) “Zeitschrift für anorganische und allgemeine Chemie (Z. Anorg. Allg. Chem.)”, 1995, Vol. 621, p. 1037, by T. Schlieper and W. Schnick

(Document 8) “Zeitschrift für anorganische und allgemeine Chemie (Z. Anorg. Allg. Chem.)”, 1995, Vol. 621, p. 1380, by T. Schlieper et al.

(Document 9) WO2004/055910 A1

Although the above-mentioned M₂Si₅N₈:Eu²⁺ in (1) and the above-mentioned CaMlSiN₃:Eu²⁺ nitride phosphor in (4) have satisfactory temperature characteristics, an impurity such as oxygen is likely to be mixed in the course of production, which makes it difficult to obtain a nitride having satisfactory crystal quality. Therefore, these phosphors have a problem that it is relatively difficult to produce a phosphor having high emission efficiency. These nitride phosphors also have a problem that it is necessary to use an ingredient (e.g., a nitride of alkaline earth metal, etc.) that is difficult to obtain due to its expense and difficult to handle in the atmosphere, and to use a complicated production process. Thus, these nitride phosphors are not suitable for industrial production.

On the other hand, the oxynitride phosphor such as Sr₂Si₄AlON₇:Eu²⁺ in (2) requires a relatively high synthesis temperature so as to obtain high performance in the course of production; however, even when an impurity such as oxygen is mixed, the influence thereof is small since the phosphor contains oxygen as a component. Thus, this phosphor is an ingredient suitable for industrial production. For example, the above-mentioned oxynitride phosphor can be produced relatively easily so as to have high emission efficiency in a single crystal phase by a production method suitable for industrial production, such as a so-called carbotherml reduction-nitridation using carbon as a reducing agent and a general ceramic material (e.g., strontium carbonate, silicon nitride, aluminum nitride, etc.) as a phosphor ingredient. However, this phosphor has a problem of poor temperature characteristics, and when the phosphor temperature increases to 100° C., for example, the emission efficiency decreases to about 80% of that at room temperature.

It is desired to develop a novel phosphor (in particular, a red phosphor) that satisfies high emission efficiency and satisfactory temperature characteristics and is suitable for industrial production, and a light-emitting device emitting light in a warm color using the phosphor.

### DISCLOSURE OF INVENTION

An oxynitride phosphor of the present invention includes a luminescent center ion in a crystal lattice of an oxynitride, wherein the oxynitride is a compound represented by a chemical formula: M₂Si₅₋ₚAlₚOₚN₈₋ₚ, where M is at least one element selected from the group consisting of Mg, Ca, Sr, Ba, and Zn, and p is a numerical value satisfying an expression: 0<p<1.

Furthermore, a light-emitting device of the present invention includes the above-mentioned oxynitride phosphor and an excitation source exciting the above-mentioned oxynitride phosphor.

### BRIEF DESCRIPTION OF DRAWINGS

FIG. 1 is a cross-sectional view of a semiconductor light-emitting device in an embodiment of the present invention.

FIG. 2 is a cross-sectional view of the semiconductor light-emitting device in the embodiment of the present invention.

FIG. 3 is a cross-sectional view of the semiconductor light-emitting device in the embodiment of the present invention.

FIG. 4 is a schematic view showing a configuration of an illumination•display device in the embodiment of the present invention.

FIG. 5 is a schematic view showing a configuration of the illumination•display device in the embodiment of the present invention.

FIG. 6 is a perspective view showing an illumination module in the embodiment of the present invention.

FIG. 7 is a perspective view showing an illumination module in the embodiment of the present invention.

FIG. 8 is a perspective view of an illumination device in the embodiment of the present invention.

FIG. 9A is a side view of the illumination device in the embodiment of the present invention.

FIG. 9B is a bottom view of the illumination device in the embodiment of the present invention.

FIG. 10 is a perspective view of an image display device in the embodiment of the present invention.

FIG. 11 is a perspective view of a numeral display device in the embodiment of the present invention.

FIG. 12 is a partial cut-away view of an end portion of a fluorescent lamp in the embodiment of the present invention.

FIG. 13 is a cross-sectional view of a double insulating configuration thin film EL panel in the embodiment of the present invention.

FIG. 14 shows an excitation spectrum and an emission spectrum of an oxynitride phosphor of Example 1 in the present invention.

FIG. 15 shows an excitation spectrum and an emission spectrum of a nitride phosphor of Comparative Example 2.

FIG. 16 shows an excitation spectrum and an emission spectrum of an oxynitride phosphor of Comparative Example 1.

FIG. 17 is a view showing a summarized X-ray diffraction pattern of phosphors of Examples 1-3, and Comparative Examples 1, 2 in the present invention.

FIG. 18 shows a relationship between a d-value and x of the phosphors of Examples 1-3, and Comparative Examples 1, 2 in the present invention.

FIG. 19 shows a relationship between a relative emission intensity and a phosphor temperature of the phosphors of Examples 1-3, and Comparative Examples 1, 2 in the present invention.

FIG. 20 shows a relationship between a relative emission intensity and a phosphor temperature of the phosphors of Examples 4-7 in the present invention.

FIG. 21 shows a relationship between a relative emission intensity and a phosphor temperature of the phosphors of Example 4 and Examples 8-10 in the present invention.

### DESCRIPTION OF THE INVENTION

The present invention provides a novel oxynitride phosphor having satisfactory emission characteristics and high emission performance. In particular, the present invention provides a novel oxynitride phosphor that satisfies both high emission efficiency and satisfactory temperature characteristics, and that emits red light most suitable for industrial production.

Furthermore, the present invention provides a light-emitting device using a phosphor composed of a novel ingredient as a light-emitting source, and in particular, a light-emitting device that has high emission efficiency even when operated at a high temperature and has a high intensity of a red light-emitting component with high brightness.

Hereinafter, the present invention will be described by way of embodiments.

In order to investigate the substitution effect and addition effect of Al with respect to a constituent element Si of a phosphor containing a luminescent center ion in a crystal lattice of a compound represented by a chemical formula: M₂Si₅N₈, and the substitution effect and addition effect of O with respect to a constituent element N of the phosphor, phosphors (M, Eu)ₐSi_{b}Al_{c}O_{d}N_{((2/3)a+(4/3)b+c-(2/3)d)} activated with some Eu²⁺ were investigated for emission characteristics. Herein, M is at least one element selected from the group consisting of Mg, Ca, Sr, Ba, and Zn, and a, b, c and d are numerical values respectively satisfying Expressions: 1.5≦a≦2.5, 4≦b≦6, 0≦c≦2, 0≦d≦2.

Consequently, it was found that red light having a high emission intensity is obtained in a particular composition range of the above-mentioned phosphor where the number of Al elements is equal to that of 0 elements. In the above-mentioned particular composition range, a, b, c and d are numerical values respectively satisfying Expressions: 1.8≦a≦2.2, 4≦b≦5, 0≦c≦1, 0≦d≦1.

The crystal constituent ingredient of a phosphor (hereinafter, referred to as a group A) in which the above-mentioned red light having a high emission intensity was compared with that of a phosphor (hereinafter, referred to as a group B) whose composition is not in the above-mentioned particular composition range, using an X-ray diffraction method. As a result, the group A exhibited an X-ray diffraction pattern similar to that of the above-mentioned nitride M₂Si₅N₈ and was composed of a substantially single compound. On the other hand, the group B exhibited an X-ray diffraction pattern different from that of the nitride M₂Si₅N₈, and was composed of a mixture of a plurality of compounds, such as a mixture of the above-mentioned nitride and another compound (for example, aluminum nitride, etc.).

Furthermore, as a result of making a detailed investigation of a phosphor in the above-mentioned group A, the phosphor found to be a solid solution (compound having a single crystal phase) of the above-mentioned nitride M₂Si₅N₈ and a conventionally known oxynitride M₂Si₄AlON₇.

It also was found that the phosphor in the group A emitted red light similar to that of a conventional M₂Si₅N₈:Eu²⁺ and M₂Si₄AlON₇:Eu²⁺ oxynitride phosphor, and had emission characteristics and emission performance comparable to those of these phosphors. More specifically, the phosphor in the group A is a red phosphor capable of being excited with light in a wavelength range in a wide range of 220 nm to 600 nm, emitting red light having an emission peak in a wavelength range of 620 nm to 640 nm, and converting blue excitation light with a wavelength of 470 nm into red light at a high absolute internal quantum efficiency of 60% or higher.

Similarly, phosphors (M, Ce)ₐSi_{b}Al_{c}O_{d}N_{((2/3)a+(4/3)b+c-(2/3)d)} activated with some Ce³⁺ were investigated for emission characteristics. Herein, M is at least one element selected from the group consisting of Mg, Ca, Sr, Ba, and Zn, and a, b, c and d are numerical values respectively satisfying Expressions: 1.5≦a≦2.5, 4≦b≦6, 0≦c≦2, 0≦d≦2.

Consequently, the following was found: there are a phosphor (group A) exhibiting an X-ray diffraction pattern similar to that of the above-mentioned nitride M₂Si₅N₈ having high an emission intensity and a phosphor (group B) exhibiting an X-ray diffraction pattern different from that of the above-mentioned nitride M₂Si₅N₈, and the phosphor in the above-mentioned group A emits green light similar to that of a conventional M₂Si₅N₈:Ce³⁺ nitride phosphor, or the like, and has emission characteristics and emission performance comparable to those of these phosphors.

Thus, the phosphor in the above-mentioned group A is a compound having a single crystal phase, which is a solid solution of the above-mentioned M₂Si₅N₈ and the above-mentioned M₂Si₄AlON₇. Therefore, the phosphor in the group A is considered to exhibit emission characteristics more satisfactory than that of the phosphor in the group B, and have emission characteristics comparable to and emission performance higher than the above-mentioned conventional nitride phosphor and the oxynitride phosphor.

Furthermore, as a result of making a detailed investigation of a numerical range of the above-mentioned x in a solid solution (1−x)(M₁₋ₙEuₙ)₂Si₅N₈.x(M₁₋ₙEuₙ)₂Si₄AlON₇ (where the M is at least one element selected from Mg, Ca, Sr, Ba, and Zn, and the above-mentioned x is a numerical value satisfying an expression: 0<x<1) of (M₁₋ₙEuₙ)₂Si₅N₈ with a luminescent center ion being Eu²⁺ and (M₁₋ₙEuₙ)₂Si₄AlON₇, and the temperature characteristics of a phosphor, the following was found: in a particular numerical range (0.2≦x≦0.8), satisfactory temperature characteristics comparable to those of conventionally known M₂Si₅N₈:Eu² nitride phosphor and CaAlSiN₃:Eu²⁺ nitride phosphor are seen.

The crystal structure and temperature characteristics regarding the above-mentioned M₂Si₄AlON₇:Eu²⁺ oxynitride phosphor were clarified for the first time, and such a fact has not been known.

The present invention was achieved based on the above finding. Hereinafter, embodiments of the present invention will be described.

### EMBODIMENT 1

First, an embodiment of an oxynitride phosphor of the present invention will be described.

An example of the oxynitride phosphor of the present invention is an oxynitride phosphor containing a luminescent center ion in a crystal lattice of an oxynitride, and the above-mentioned oxynitride is a compound represented by a chemical formula: M₂Si₅₋ₚAlₚOₚN₈₋ₚ where M is at least one element selected from the group consisting of Mg, Ca, Sr, Ba, and Zn, and p is a numerical value satisfying 0<p<1.

The oxynitride phosphor is a compound that is a phosphor containing a luminescent center ion in a crystal lattice of a compound represented by a chemical formula: M₂Si₅₋ₚAlₚOₚN₈₋ₚ to be a phosphor host, and that has a single crystal phase composed of a single compound. Owing to such a configuration, a phosphor having satisfactory emission characteristics and high emission performance can be obtained.

If the above-mentioned p is a numerical value satisfying 0.7≦p<1, a phosphor having a composition different from that of a conventional phosphor is obtained. Furthermore, if the above-mentioned p is a numerical value satisfying 0.7≦p≦0.9, more preferably 0.7≦p≦0.8, the above-mentioned oxynitride phosphor becomes a phosphor having a composition apparently different from that of a conventional phosphor.

It is preferable that the above-mentioned oxynitride phosphor does not contain an impurity. However, for example, the above-mentioned oxynitride phosphor may contain at least one metal impurity element in an amount corresponding to less than 10 atomic % of an element such as M, Al, Si, or the like in the above chemical formula. More specifically, for the purpose of slightly improving the emission performance of an oxynitride phosphor, a trace amount or a small amount of impurity element can be added, and the oxynitride phosphor can have a composition slightly shifted from a stoichiometric chemical composition in a range of a composition apparently different from that of a known phosphor composition. For example, for the purpose of slightly improving emission performance, a part of Si contained in the oxynitride phosphor can be replaced by at least one element capable of assuming tetravalence such as Ge and Ti, or a part of Al can be replaced by at least one element capable of assuming trivalence such as B, Ga, In, Sc, Y, Fe, Cr, Ti, Zr, Hf, V, Nb, and Ta. Herein, the above-mentioned part refers to, for example, that the number of atoms with respect to Si and Al is less than 30 atomic %.

The luminescent center ion can be selected appropriately from rare-earth ions (e.g., Eu²⁺, Ce³⁺, Pr³⁺, Eu³⁺, Dy³⁺, Nd³⁺, Tb³⁺, Yb²⁺, etc.) and transition metal ions (e.g., Mn²⁺, etc.). If the above-mentioned luminescent center ion is Ce³⁺ or Tb³⁺, a phosphor emitting green light is obtained, and if the above-mentioned luminescent center ion is Eu³⁺, a phosphor emitting red light having an emission spectrum shape in a bright line shape is obtained.

The adding amount of the above-mentioned luminescent center ion is 0.1 atomic % to 30 atomic %, preferably 0.5 atomic % to 10 atomic %, and more preferably 1 atomic % to 5 atomic % with respect to the above-mentioned M. If the adding amount is in this range, an oxynitride phosphor satisfying both satisfactory emission color and high brightness is obtained. The luminescent center ion is added so as to replace a part of a lattice position of an element M. Furthermore, for example, in the case of adding a trivalent ion such as Ce³⁺ as a luminescent center ion, it is preferable to add an alkali metal ion (e.g., Li, Na, K, etc.) having substantially the same atomic number as that of the luminescent center ion, for the purpose of compensating for a charge, and thus, a luminescent center ion in a high concentration of 1 atomic % or more can be activated.

In the oxynitride phosphor of the present embodiment, the above-mentioned luminescent center ion preferably is at least one selected from Eu²⁺ and Ce³⁺, since an oxynitride phosphor emitting light at high emission efficiency is obtained under the condition of excitation with near-ultraviolet—violet—blue light. Furthermore, by adding Eu²⁺, the phosphor is excited with near-ultraviolet—violet—blue light to become a phosphor emitting red light. By adding Ce³⁺, the phosphor is excited with near-ultraviolet—violet—blue light to become a phosphor emitting green light.

Furthermore, in the oxynitride phosphor of the present embodiment, the above-mentioned luminescent center ion can be contained in combination of two or more ions selected from Eu²⁺, Ce³⁺, Dy³⁺, and Nd³⁺. At this time, the oxynitride phosphor becomes a phosphor obtained by coactivating a plurality of luminescent center ions. For example, a phosphor coactivated with Ce³⁺ and Eu²⁺, a phosphor coactivated with Eu²⁺ and Dy³⁺, a phosphor coactivated with Eu²⁺ and Nd³⁺, and the like are obtained. By obtaining such a phosphor, using a phenomenon in which energy transition from one luminescent center ion to another luminescent center ion occurs, a phosphor in which the shapes of an excitation spectrum and an emission spectrum are controlled can be obtained, and a long afterglow phosphor can be obtained using an excitation phenomenon owing to heat.

It is more preferable that the oxynitride phosphor of the present embodiment is a compound represented by a chemical formula: (1−x)(M₁₋ₙEuₙ)₂Si₅N₈.x(M₁₋ₙEuₙ)₂Si₄AlON₇, where x is a numerical value satisfying 0.2≦x≦0.8, and n is a numerical value satisfying 0.001≦n≦0.3. In other words, this phosphor is a solid solution of an nitride phosphor represented by a chemical formula: (M₁₋ₙEuₙ)₂Si₅N₈ and an oxynitride phosphor represented by a chemical formula: (M₁₋ₙEuₙ)₂Si₄AlON₇.

Furthermore, it is more preferable that the above-mentioned x is a numerical value satisfying 0.5≦x≦0.8, in particular, 0.7≦x≦0.8 for the following reason. The resultant phosphor contains an oxygen component in a relatively larger amount compared with the conventionally known (M₁₋ₙEuₙ)₂Si₅N₈, so that the phosphor can be produced relatively easily, and a phosphor having satisfactory emission performance is obtained since it contains a relatively smaller amount of an aluminum component, compared with the conventionally known (M₁₋ₙEuₙ)₂Si₄AlON₇. It is more preferable that the above-mentioned n is a numerical value satisfying 0.005≦n≦0.1, in particular, 0.01≦n≦0.05, because a phosphor having a high absolute internal quantum efficiency (e.g., a phosphor capable of converting blue excitation light to red light at a high conversion efficiency).

An oxynitride phosphor close to a nitride phosphor having a small ratio of an oxygen component has satisfactory temperature characteristics. However, in producing such a phosphor, in the same way as in the case of producing a pure nitride phosphor, the influence of an ingredient for a phosphor, the impurity oxygen component contained in a trace amount in a sintering atmosphere, and water vapor cannot be ignored, so that it is difficult to produce an oxynitride phosphor of high quality with good reproducibility. Furthermore, in producing an oxynitride phosphor close to a nitride phosphor containing metal (e.g., Mg, Ca, Sr, etc.) with a relatively small ion radius, silicon, and aluminum, a SIALON-based phosphor is likely to be generated as a sub-product, so that there is a problem that the emission color of a phosphor is likely to be yellowish due to the mixing of the phosphor of the sub-product.

On the other hand, an oxynitride phosphor having a large ratio of an aluminum component has a problem that the temperature extinction is large and the emission efficiency decreases largely along with an increase in a phosphor temperature. Furthermore, in production of such a phosphor, the reaction among phosphor ingredients is relatively unlikely to proceed, so that it is necessary to effect a reaction at a relatively high temperature so as to obtain a phosphor having high performance. Therefore, it is considered not to be easy to produce an oxynitride phosphor of high quality containing a large ratio of an aluminum component. However, such an oxynitride phosphor necessarily has a large ratio of an oxygen component, and the change in characteristics due to an impurity oxygen mixed in a phosphor in the course of production is small. This superiority is high, so that an oxynitride phosphor containing a large ratio of an aluminum component is considered to be suitable for industrial production.

For the above reason, it is not preferable that the composition of the above-mentioned oxynitride phosphor is too close to that of the above-mentioned (M₁₋ₙEuₙ)₂Si₅N₈, and is too close to that of the above-mentioned (M₁₋ₙEuₙ)₂Si₄AlON₇.

In the oxynitride phosphor of the present embodiment, it is more preferable that a main component of M in the above-mentioned chemical formula is Sr, because the wavelength of excitation light can be converted at higher quantum conversion efficiency to emit light. The main component of the above-mentioned M being Sr means that a majority of the element M, preferably 80 atomic % or more of the element M is Sr.

In the present embodiment, an oxynitride phosphor preferably has a composition in which all the above-mentioned M is set to be at least one element selected from Mg, Ca, Sr, Ba, and Zn, in terms of the management and production of an ingredient. The oxynitride phosphor most preferably has a composition in which all the above-mentioned M is set to be Sr.

Furthermore, in the present embodiment, the oxynitride phosphor preferably has a composition in which the above-mentioned M contains Sr as a main component and further contains at least one element selected from Ba and Ca, in terms of temperature characteristics. That is, it is preferable that the replacement amount of Ba and Ca with respect to the above-mentioned M is less than 50 atomic %. With such a composition, an oxynitride phosphor emitting light with a high emission intensity and small temperature extinction is obtained. In particular, if a majority of the above-mentioned M is occupied by Sr, and the replacement amount of Ba with respect to the above-mentioned M is less than 50 atomic %, an oxynitride phosphor having satisfactory spectral luminous efficacy, emitting red light having a relatively high intensity, and having small temperature extinction is obtained.

Herein, the temperature characteristics of the oxynitride phosphor of the present embodiment will be described in detail.

The x preferable in terms of temperature characteristics is a numerical value in a range of 0<x≦0.75, and the p is a numerical value in a range of 0<p≦0.75. In this numerical value range, at least, temperature characteristics that are more satisfactory than those with a composition of x=1 or p=1 are obtained. Furthermore, the x preferably is a numerical value in a range of 0.1≦x≦0.75, and the p is a numerical value in a range of 0.1≦p≦0.75. In this numerical value range, satisfactory temperature characteristics equal to or more than the composition of x=0 or p=0 are obtained. Furthermore, the above-mentioned x preferably is a numerical value satisfying 0.1≦x≦0.6, in particular 0.2≦x≦0.6. The above-mentioned p is a numerical value satisfying 0.1≦p≦0.6, in particular, 0.2≦p≦0.6. In this numerical value range, temperature characteristics more satisfactory than those of the composition of x=0 or p=0 are obtained.

When both aspects of production and temperature characteristics are considered, the above-mentioned x is considered to be preferably a numerical value in a range satisfying 0.5≦x≦0.6.

The oxynitride phosphor of the present embodiment is not particularly limited by its property and the like. For example, the oxynitride phosphor may be, for example, a single crystalline bulk, a ceramic molding, a thin film having a thickness of several nm to several μm, a thick film having a thickness of several 10 μm to several 100 μm, powder, or the like. For the purpose of application to a light-emitting device, the oxynitride phosphor preferably is powder, and more preferably is powder with a center grain size (D50) of 0.1 μm to 30 μm (preferably 0.5 μm to 20 μm). Furthermore, the shape of a particle itself of the above-mentioned oxynitride phosphor is not particularly limited, and for example, the oxynitride phosphor may have a spherical shape, a plate shape, a bar shape, or the like. The oxynitride phosphor also may be dispersed in glass (e.g., crystallized glass).

An oxynitride phosphor activated with Eu²⁺ that is an example of the oxynitride phosphor of the present embodiment is excited with ultraviolet—near-ultraviolet—violet—blue—green—yellow—orange light of 250 nm to 600 nm, preferably near-ultraviolet—violet—blue—green light of 360 nm to 560 nm, and emits light of 610 nm to 650 nm, in particular, 620 nm to 635 nm. The above-mentioned oxynitride phosphor can emit red light with a spectral luminous efficacy more satisfactory than that of, for example, a CaAlSiN₃:Eu²⁺ red phosphor.

Furthermore, in the oxynitride phosphor activated with Eu²⁺ that is an example of the oxynitride phosphor of the present embodiment, the shapes of its excitation spectrum and emission spectrum become comparable to those of the above-mentioned M₂Si₅N₈:Eu²⁺ nitride phosphor and Sr₂Si₄AlON₇:Eu²⁺ oxynitride phosphor. Furthermore, the emission intensity, emission characteristics, emission performance, and the like also become comparable to those of these phosphors.

The oxynitride phosphor activated with Eu²⁺ that is an example of the oxynitride phosphor of the present embodiment can be produced, for example, by the following method.

First, as ingredients for forming a phosphor host, a nitride (M₃N₂), silicon nitride (Si₃N₄), aluminum nitride (AlN), and aluminum oxide (Al₂O₃) are prepared. M is at least one element selected from the group consisting of Mg, Ca, Sr, Ba, and Zn. Furthermore, as an ingredient for adding Eu²⁺, a compound containing a europium element is prepared. Examples of the ingredient for adding Eu²⁺ include an oxide, a nitride, and a halide of europium. Specific examples thereof include europium oxide, europium nitride, europium chloride, and europium fluoride.

Next, these phosphor ingredients are weighed and mixed so that each atom constitutes a compound represented by a chemical formula: (1−x)(M₁₋ₙEuₙ)₂Si₅N₈.x(M₁₋ₙEuₙ)₂Si₄AlON₇ with a desired atomic ratio, thereby obtaining a mixed ingredient. Herein, x is a numerical value satisfying 0.2≦x≦0.8, and the above-mentioned n is a numerical value satisfying 0.001≦n≦0.3. Then, the above-mentioned mixed ingredient is sintered in any of a vacuum atmosphere, a neutral atmosphere (e.g., inactive gas, nitrogen gas, etc.), a reducing atmosphere (e.g., CO, nitrogen-hydrogen mixed gas, ammonia gas, etc.).

Although it is more preferable that the above-mentioned reaction atmosphere is an atmospheric atmosphere for the reason that a simple facility can be used, any of a high-pressure atmosphere, a pressurized atmosphere, a pressure-reducing atmosphere, and a vacuum atmosphere may be used. However, for the purpose of enhancing the performance of the oxynitride phosphor, a more preferable reaction atmosphere is a high-pressure atmosphere (e.g., an atmosphere mainly containing nitrogen gas of 0.5 MPa to 2 MPa. In such a high-pressure atmosphere, the decomposition of the oxynitride phosphor occurring during sintering at a high temperature can be prevented or suppressed, and the shift of a composition is suppressed, whereby a phosphor having high brightness performance can be produced. Furthermore, for the purpose of generating Eu²⁺ in a large amount, a reducing atmosphere (e.g., an nitrogen-hydrogen mixed gas atmosphere) is more preferable.

The above-mentioned sintering temperature is, for example, 1300° C. to 2000° C., and for the purpose of enhancing the performance of the oxynitride phosphor, the sintering temperature is preferably 1400° C. to 1900° C., more preferably 1500° C. to 1800° C. On the other hand, for the purpose of mass-production, the sintering temperature is preferably 1400° C. to 1800° C., more preferably 1400° C. to 1600° C. The sintering time is, for example, 30 minutes to 100 hours, and considering productivity, the preferable sintering time is 2 to 8 hours. Sintering may be performed in divided portions in different atmospheres or in the same atmosphere. A sintered substance obtained by such sintering becomes an oxynitride phosphor.

Furthermore, the oxynitride phosphor activated with Eu²⁺ that is an example of the oxynitride phosphor of the present embodiment also can be produced by carbothermal reduction-nitridation using carbon as a reducing agent.

According to the carbothermal reduction-nitridation, as ingredients for forming a phosphor host, an alkaline earth metal salt (e.g., MCO₃, etc.), silicon nitride (Si₃N₄), aluminum nitride (AlN), and carbon (C) as a reducing agent are prepared. Herein, M is at least one element selected from the group consisting of Mg, Ca, Sr, Ba, and Zn. Furthermore, as an ingredient for adding Eu²⁺, a europium compound such as europium oxide is prepared.

Next, these phosphor ingredients are weighed and mixed so that carbon functions as a reducing agent, the alkaline earth metal compound (e.g., an alkaline earth metal oxide obtained when the above-mentioned MCO₃ releases carbon dioxide, etc.) is nitrided in a nitriding gas atmosphere while being reduced and reacts with another ingredient to generate a compound represented by a chemical formula: (1−x)(M₁₋ₙEuₙ)₂Si₅N₈.x(M₁₋ₙEuₙ)₂Si₄AlON₇ with a desired atomic ratio, whereby a mixed ingredient is obtained. Then, the mixed ingredient is sintered in an atmosphere of nitriding gas (e.g., nitrogen gas, nitrogen-hydrogen mixed gas, ammonia gas, etc.) to be synthesized.

If the carbothermal reduction-nitridation is used, an oxynitride phosphor having a single crystal phase and high efficiency can be produced easily using a general ceramic material that is easy to obtain, inexpensive, and easy to handle in an atmosphere, without using a nitride (M₃N₂) of alkaline earth metal that is difficult to obtain, expensive, and difficult to handle in an atmosphere. Therefore, the oxynitride phosphor according to the present invention can be provided in a large amount at a low cost.

The oxynitride phosphor of the present embodiment is not limited to those produced by the above production method. For example, the oxynitride phosphor also can be produced not only by the above-mentioned solid-phase reaction but also by a solid-phase reaction other than the above, and also can be produced by a procedure using a vapor-phase reaction, a liquid-phase reaction, or the like.

### EMBODIMENT 2

Next, an embodiment of a light-emitting device of the present invention will be described.

An exemplary light-emitting device of the present invention is not particularly limited in its configuration and the like, as long as it is a light-emitting device including the above-mentioned oxynitride phosphor of Embodiment 1 and an excitation source exciting the above-mentioned oxynitride phosphor, and including the above-mentioned oxynitride phosphor as a light-emitting source. The above-mentioned oxynitride phosphor is excited by the excitation source to emit light. As the excitation source, for example, at least one electromagnetic wave selected from an ultraviolet ray, a near-ultraviolet ray, a visible ray (violet; blue, green light beam, etc.), a near infrared ray, an infrared ray, and the like, or a particle beam such as an electron beam can be used. Furthermore, an excitation source also can be used, which excites the above-mentioned oxynitride phosphor by applying an electric field thereto, injecting an electron thereto, or the like.

The light-emitting device of the present embodiment is a device known as, for example, the following names (1) to (6):

(1) fluorescent lamp, (2) plasma display panel (PDP), (3) inorganic electroluminescence (EL) panel, (4) field emission display (5) cathode-ray tube, (6) white LED light source.

More specific examples of the light-emitting device of the present embodiment include a white LED, various kinds of display devices configured using a white LED (e.g., an LED lamp for automobiles such as a stop lamp, a direction indicator, and a headlight, a LED information display terminal, an LED traffic signal light, etc.), various kinds of illumination devices configured using a white LED (e.g., an LED indoor/outdoor illumination light, an interior LED light, an LED emergency light, an LED light source, an LED decoration light, etc.), various kinds of display devices without using a white LED (e.g., a cathode-ray tube, an EL panel, a PDP, etc.), and various kinds of illumination devices without using a white LED (e.g., a fluorescent light).

Furthermore, in another aspect, the light-emitting device of the present embodiment is, for example, a white light-emitting element obtained by combining an injection-type EL element (e.g., a light-emitting diode (LED), a laser diode (LD), an organic EL element, etc.) emitting near-ultraviolet light, violet light, or blue light with at least the oxynitride phosphor of Embodiment 1, various kinds of light sources, an illumination device, a display device, or the like. A display device, an illumination device, a light source, a light source system (e.g., an endoscope system for medical use, etc.) or the like configured using at least one of the above-mentioned white light-emitting element also is included in the above-mentioned light-emitting device.

The light-emitting device of the present embodiment is a light-emitting device in which the above-mentioned oxynitride phosphor of Embodiment 1 is included in a light-emitting source, and is a light-emitting device using a light-emitting source emitting red light having an emission peak in a wavelength range of preferably 610 nm to 650 nm, and emitting red light having an emission peak in a wavelength range of more preferably 620 nm to 635 nm.

Furthermore, the light-emitting device of the present embodiment is preferably a light-emitting device including an excitation source emitting light near-ultraviolet—violet—blue—green color having an emission peak in a wavelength range of 360 nm to less than 560 nm, and more preferably a light-emitting device emitting light in a warm color. More specifically, the light-emitting device of the present embodiment is a light-emitting device including an excitation source having an emission peak in a wavelength range of any of 360 nm to less than 420 nm, 420 nm to less than 500 nm, and 500 nm to less than 560 nm, and a phosphor that is excited with light emitted by the excitation source and emits visible light having a wavelength longer than that of the light emitted by the excitation source, wherein the phosphor contains at least the above-mentioned oxynitride phosphor, and more preferably emits light in a warm color having an emission peak in a wavelength range of 600 nm to less than 660 nm.

The above-mentioned excitation source preferably is a light-emitting element emitting the above-mentioned light as excitation light of the oxynitride phosphor. Thus, the miniaturization and reduction in thickness of the light-emitting device can be performed, and a small or thin light-emitting device can be provided.

It is preferable that the light-emitting device of the present embodiment uses an injection-type EL element as the above-mentioned excitation source. This is because a small or thin light-emitting device emitting light with high output can be provided. The injection-type EL element refers to a photoelectric transducer configured so as to convert electric energy into light energy and obtain emission by injecting an electron to a fluorescent material. The specific example thereof has been described above.

The light-emitting device of the present embodiment uses a novel oxynitride phosphor, so that it includes a phosphor composed of a novel material as a light-emitting source. In particular, if an oxynitride phosphor emitting red light is used as a light-emitting source, a light-emitting device is obtained in which the intensity of a red light-emitting component is high, and the numerical value of a special rendition evaluation index R9 is large.

Furthermore, a light-emitting device also can be configured using an oxynitride phosphor having satisfactory temperature characteristics, so that a light-emitting device with a high luminous flux and high brightness is obtained. More specifically, a light-emitting device with a high luminous flux or brightness is obtained, since the temperature extinction is small even when a phosphor is exposed to a temperature condition of 80° C. to 200° C., in particular, 100° C. to 180° C. Furthermore, a light-emitting device also can be configured using an oxynitride phosphor produced by a production method at a low production cost, so that an inexpensive light-emitting device also can be provided. Above all, it is preferable to configure a light-emitting device which uses a light-emitting element such as an injection-type EL element as an excitation source, and in which the light-emitting element is in contact with a phosphor layer containing an oxynitride phosphor having satisfactory temperature characteristics, because the phosphor layer can be irradiated with light emitted from the light-emitting element efficiently, whereby the emission performance is enhanced.

Hereinafter, an embodiment of the present invention will be described with reference to the drawings. In the following embodiment, like components are denoted with like reference numerals, and the repetition of the description may be omitted.

There is no particular limit on a light-emitting device of the present embodiment, as long as it includes the above-mentioned oxynitride phosphor of Embodiment 1 and an excitation source exciting the above-mentioned oxynitride phosphor, and uses the above-mentioned oxynitride phosphor as a light-emitting source. Furthermore, in a preferable embodiment, a phosphor and a light-emitting element containing the above-mentioned oxynitride phosphor is used as a light-emitting source, and the phosphor covers the light-emitting element.

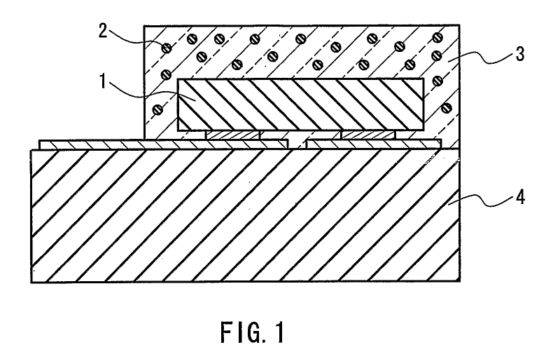

FIGS. 1, 2, and 3 are cross-sectional views of a semiconductor light-emitting device that is a representative embodiment of a light-emitting device obtained by combining a phosphor containing the oxynitride phosphor of Embodiment 1 with a light-emitting element.

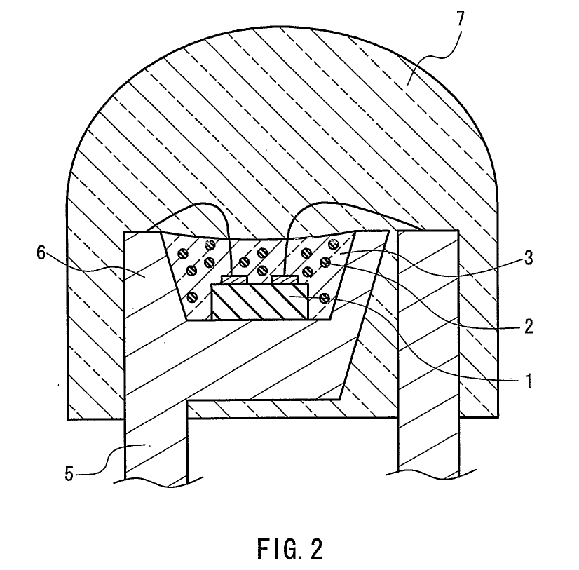

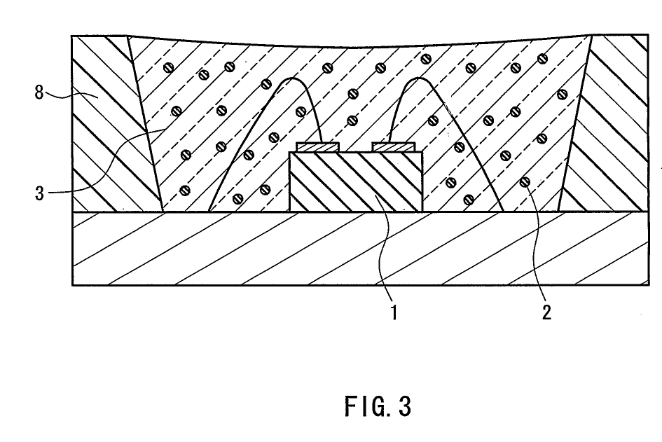

FIG. 1 shows a semiconductor light-emitting device having a configuration in which at least one light-emitting element 1 is mounted on a submount element 4, and the light-emitting element 1 is sealed in a package of a base material (e.g., transparent resin, low-melting glass) that also functions as a phosphor layer 3 including a phosphor 2 containing at least the oxynitride phosphor of Embodiment 1. FIG. 2 shows a semiconductor light-emitting device having a configuration in which at least one light-emitting element 1 is mounted on a cup 6 provided at a mount lead of a lead frame 5, the phosphor layer 3 formed of a base material including the phosphor 2 containing at least the oxynitride phosphor of Embodiment 1 is provided in the cup 6, and the entire body is sealed with a sealant 7 made of resin or the like. FIG. 3 shows a semiconductor light-emitting device of a chip type having a configuration in which at least one light-emitting element 1 is placed in a housing 8, and the phosphor layer 3 formed of a base material including the phosphor 2 containing at least the oxynitride phosphor of embodiment 1 is provided in the housing 8.

In FIGS. 1 to 3, the light-emitting element 1 is a photoelectric transducer that converts electric energy into light. Specific examples of the light-emitting element 1 include a light-emitting diode (LED), a laser diode (LD), a surface-emitting LD, an inorganic electroluminescence (EL) element, an organic EL element, and the like. In particular, the LED or the surface-emitting LD is preferable in terms of the high output of the semiconductor light-emitting device. Although the wavelength of light emitted by the light-emitting element 1 is not particularly limited, it is preferable that the wavelength has an emission peak in a wavelength range (e.g., 250 to less than 560 nm) capable of exciting the oxynitride phosphor. Furthermore, in order to produce a semiconductor light-emitting device with high emission performance, in which the oxynitride phosphor is excited at a high efficiency and which emits white light, it is preferable to use the light-emitting element 1 having an emission peak in a wavelength range of 340 nm to 500 nm, preferably 350 nm to 420 nm, or 420 nm to 500 nm, more preferably 360 nm to 410 nm, or 440 nm to 480 nm (i.e., in a near-ultraviolet—violet—blue wavelength range).

Furthermore, in FIGS. 1 to 3, the phosphor layer 3 includes the phosphor 2 containing at least the oxynitride phosphor of Embodiment 1. The phosphor layer 3 is configured, for example, by dispersing at least the phosphor 2 in a transparent base material such as transparent resin (epoxy resin, silicon resin, etc.), low-melting glass, or the like. The content of the phosphor 2 in the transparent base material is preferably 5 to 80% by weight, more preferably 10 to 60% by weight, for example, in the case of the above-mentioned transparent resin. The oxynitride phosphor present in the phosphor layer 3 emits light by absorbing a part or an entirety of light emitted by the light-emitting element 1, so that the output light of the semiconductor light-emitting device contains at least a light-emitting component emitted by the oxynitride phosphor.

Accordingly, if the light-emitting element 1 and the phosphor 2 are set to have, for example, the following combination, white light is obtained owing to the color mixture of light emitted by the light-emitting element 1 and light emitted by the phosphor layer 3, and hence, a semiconductor light-emitting device emitting white light, which is highly demanded, can be obtained.

(1) A combination of the light-emitting element 1 emitting any light of near-ultraviolet light (wavelength: 300 nm to less than 380 nm, preferably 350 nm to less than 380 nm in terms of the output) and violet light (wavelength: 380 nm to less than 420 nm, preferably 395 nm to less than 415 nm in terms of the output), and the phosphor 2 composed of a blue phosphor, a green phosphor, and the oxynitride phosphor of Embodiment 1.

(2) A combination of the light-emitting element 1 emitting any light of the above-mentioned near-ultraviolet light and the above-mentioned violet light, and the phosphor 2 composed of a blue phosphor, a green phosphor, a yellow phosphor, and the above-mentioned oxynitride phosphor.

(3) A combination of the light-emitting element 2 emitting any light of the above-mentioned near-ultraviolet light and the above-mentioned violet light, and the phosphor 2 composed of a blue phosphor, a yellow phosphor, and the above-mentioned oxynitride phosphor.

(4) A combination of the light-emitting element 1 emitting blue light (wavelength: 420 nm to less than 490 nm, preferably 450 nm to less than 480 nm in terms of the output), and the phosphor 2 composed of a green phosphor, a yellow phosphor, and the above-mentioned oxynitride phosphor.

(5) A combination of the light-emitting element 1 emitting the above-mentioned blue light, and the phosphor 2 composed of a yellow phosphor and the above-mentioned oxynitride phosphor.

(6) A combination of the light-emitting element 1 emitting the above-mentioned blue light, and the phosphor 2 composed of a green phosphor and the above-mentioned oxynitride phosphor.

(7) A combination of the light emitting element 1 emitting blue-green light (wavelength: 490 nm to less than 510 nm) and the above-mentioned oxynitride phosphor.

As the above-mentioned blue phosphor, green phosphor, and yellow phosphor, for example, an aluminate phosphor activated with Eu²⁺, a halophosphate phosphor activated with Eu²⁺, a phosphate phosphor activated with Eu²⁺, a silicate phosphor activated with Eu²⁺, a garnet phosphor activated with Ce³⁺ (in particular, YAG (yttrium-aluminum-garnet): Ce phosphor), a silicate phosphor activated with Tb³⁺, a thiogallate phosphor activated with Eu²⁺, a nitride phosphor activated with Eu²⁺ (in particular, a SIALON phosphor), or the like may be used. More specifically, for example, a (Ba, Sr)MgAl₁₀O₁₇:Eu²⁺ blue phosphor, a (Sr, Ca, Ba, Mg)₁₀(PO₄)₆C₁₂:Eu²⁺ blue phosphor, a (Ba, Sr)₂SiO₄:Eu²⁺ green phosphor, a BaMgAl₁₀O₁₇:Eu²⁺, a Mn²⁺ green phosphor, a Y₃(Al, Ga)₅O₁₂:Ce³⁺ green phosphor, a Y₃Al₅O₁₂:Ce³⁺ green phosphor, a BaY₂SiAl₄O₁₂:Ce³⁺ green phosphor, a Ca₃Sc₂Si₃O₁₂:Ce³⁺ green phosphor, a SrGa₂S₄:Eu²⁺ green phosphor, a (Y, Gd)₃Al₅O₁₂:Ce³⁺ yellow phosphor, a (Sr, Ba)₂SiO₄:Eu²⁺ yellow phosphor, a CaGa₂S₄:Eu²⁺ yellow phosphor, a 0.75 CaO.2.25 AlN.3.25 Si₃N₄:Eu²⁺ yellow phosphor, or the like can be used.

Furthermore, the above-mentioned oxynitride phosphor also can be excited with green light (wavelength: 510 nm to less than 560 nm) or yellow light (wavelength: 560 nm to less than 590 nm). Therefore, a semiconductor light-emitting device also can be produced, which has a configuration in which the light-emitting element 1 emitting any of the above-mentioned green light and yellow light is combined with the phosphor 2 containing the oxynitride phosphor. Furthermore, if the above-mentioned oxynitride phosphor has an emission peak in a wavelength range of 615 nm to 635 nm, a semiconductor light-emitting device such as a white LED emitting light having a satisfactory color rendering property can be provided. According to simulation, for example, by combining the above-mentioned oxynitride phosphor with the light-emitting element 1 emitting any of near-violet light and violet light, a light-emitting device can be provided, which emits white light whose color rendering property evaluation numbers R1 to R8 and special color rendering property evaluation numbers R9 to R15, as well as an average color rendering property evaluation number Ra exceed 80. Furthermore, by optimizing the combination of materials, a light-emitting device also can be provided, which emits white light whose average color rendering property evaluation number, color rendering property evaluation number, and special color rendering property evaluation number exceed 90.

The phosphor layer 3 may be composed of a plurality of layers or a multi-layered configuration, and a part of the plurality of layers or the multi-layered configuration may be a phosphor layer including the phosphor 2 containing at least the oxynitride phosphor of Embodiment 1. Such a configuration is preferable, because color blur and output blur of emitted light of the semiconductor light-emitting device of the present embodiment can be suppressed.

If the oxynitride phosphor activated with Eu²⁺ described in Embodiment 1, which is chemically stable and emits light containing a red light-emitting component in a large amount and having a high emission intensity by being excited with near-ultraviolet—violet—blue light, is used, the semiconductor light-emitting device of the present embodiment has a high emission intensity of a red light-emitting component and excellent reliability.

Furthermore, the semiconductor light-emitting device of the present embodiment also can be configured using an oxynitride phosphor having satisfactory temperature characteristics, so that the semiconductor light-emitting device has a high luminous flux or high brightness. More specifically, even when the phosphor is exposed to the temperature condition of 80° C. to 200° C. (in particular, 100° C. to 180° C.), temperature extinction is small, so that the semiconductor light-emitting device has a high luminous flux or brightness. Furthermore, the semiconductor light-emitting device of the present embodiment also can be configured using the oxynitride phosphor produced by a production method that costs less, so that an inexpensive semiconductor light-emitting device can be provided. Above all, it is preferable to configure a semiconductor light-emitting device in which a light-emitting element such as an injection-type EL element is used as an excitation source of a phosphor, and the light-emitting element is in contact with a phosphor layer containing an oxynitride phosphor with satisfactory temperature characteristics, because light emitted by the light-emitting element can be irradiated to a phosphor layer with good efficiency, which enhances emission performance.

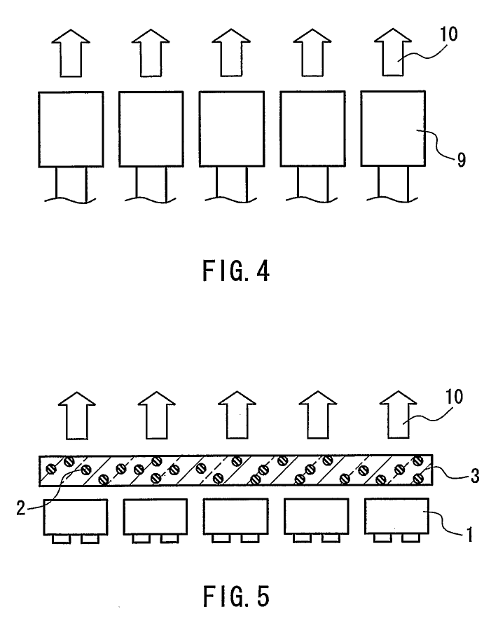

FIGS. 4 and 5 respectively show a schematic view of a configuration of an illumination•display device that is an example of the light-emitting device of the present invention.

FIG. 4 shows an illumination•display device configured using at least one semiconductor light-emitting device 9 in which a phosphor containing the oxynitride phosphor of Embodiment 1 is combined with the light-emitting element. FIG. 5 shows an illumination•display device including a combination of the light-emitting element 1 and the phosphor layer 3 including the phosphor 2 containing the oxynitride phosphor of Embodiment 1. As the semiconductor light-emitting device 9, the light-emitting element 1, and the phosphor layer 3, the ones similar to those shown in FIGS. 1 to 3 can be used. Furthermore, the functions and effects of the illumination•display device with such a configuration also are similar to those of the semiconductor light-emitting device shown in FIGS. 1 to 3. In FIGS. 4 and 5, reference numeral 10 denotes output light.

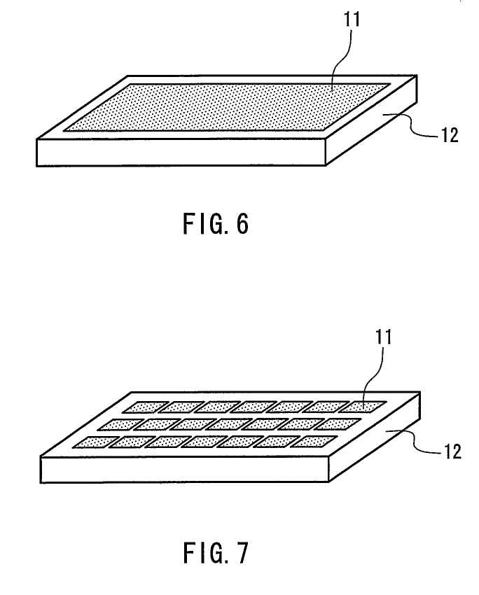

FIGS. 6 to 11 show specific examples of various kinds of light-emitting devices in which the illumination•display device of the present embodiment schematically shown in FIGS. 4 and 5 are incorporated as a light-emitting portion 11.

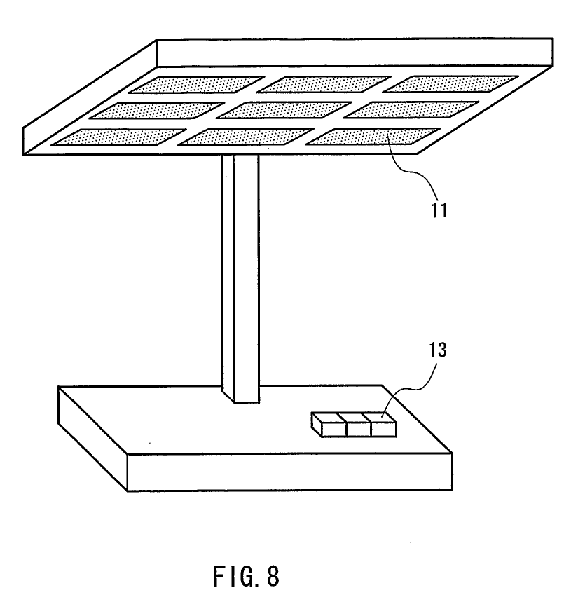

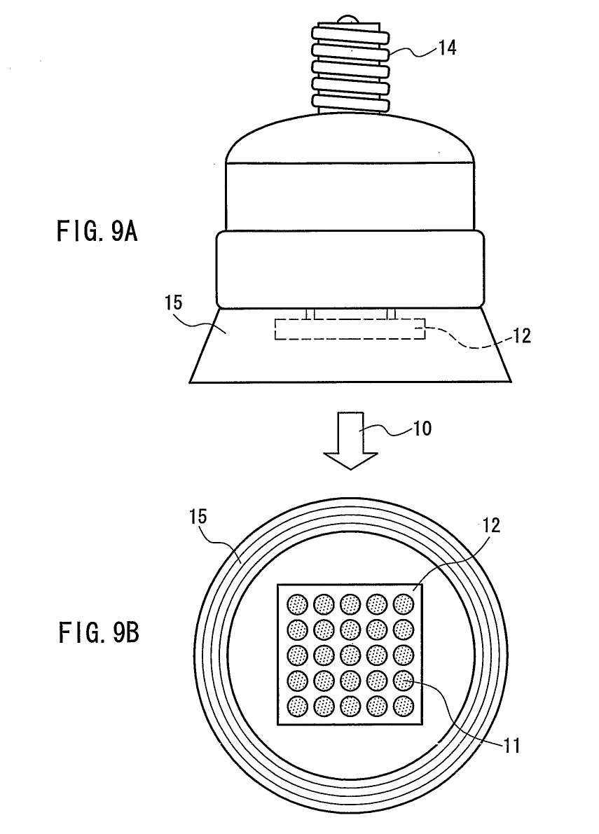

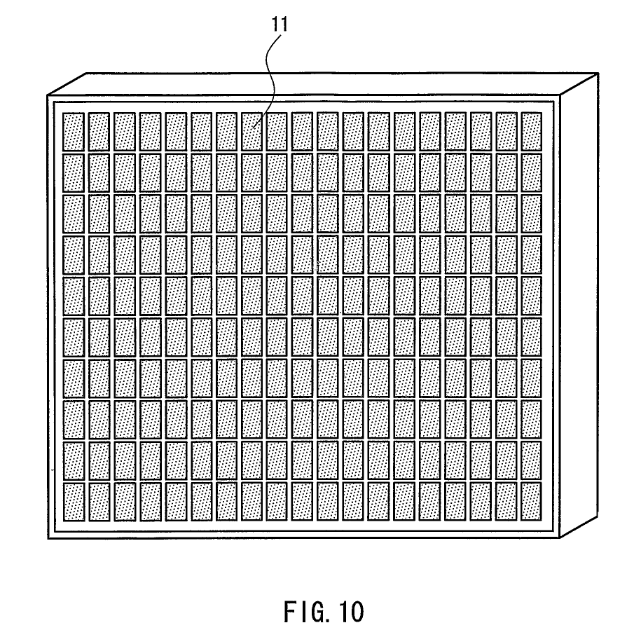

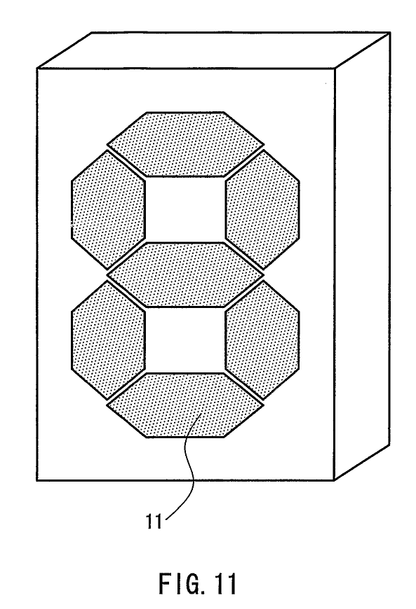

FIG. 6 shows a perspective view of an illumination module 12 having an integrated light-emitting portion 11. FIG. 7 shows a perspective view of the illumination module 12 having a plurality of light-emitting portions 11. FIG. 8 is a perspective view of a table lamp type illumination device having the light-emitting portions 11 and being capable of controlling ON-OFF and light amount with a switch 13. FIG. 9A is a side view of an illumination device provided with a screw cap 14, a reflective plate 15, and an illumination module 12 having a plurality of light-emitting portions 11, and FIG. 9B is a bottom view of the illumination device shown in FIG. 9A. FIG. 10 is a perspective view showing a plate type image display device provided with the light-emitting portions 11. FIG. 11 is a perspective view showing a segmented number display device provided with the light-emitting portions. 11.

If the illumination•display device in the present embodiment is configured using the oxynitride phosphor activated with Eu²⁺ described in Embodiment 1, which is chemically stable and emits light containing a large amount of red light-emitting component and having a high emission intensity, and a light-emitting device having a high emission intensity of a red light-emitting component and being excellent in reliability, the illumination•display device of the present embodiment has a higher emission intensity of a red light-emitting component and is more excellent in reliability, compared with the conventional illumination•display device.

Furthermore, the illumination•display device of the present embodiment can be configured so as to include a light-emitting device using an oxynitride phosphor with satisfactory temperature characteristics, so that the device has a high luminous flux or high brightness. More specifically, even when the phosphor is exposed to the temperature condition of 80° C. to 200° C. (in particular, 100° C. to 180° C.), the temperature extinction is small, so that the light-emitting device has a high luminous flux or high brightness. Furthermore, the light-emitting device also can be configured using an oxynitride phosphor produced by a production method that costs less, and an inexpensive illumination•display device can be provided. Above all, it is preferable to configure a semiconductor light-emitting device in which a light-emitting element such as an injection-type EL element is used as an excitation source, and the light-emitting element is in contact with a phosphor layer containing an oxynitride phosphor with satisfactory temperature characteristics, because light emitted by the light-emitting element can be irradiated to a phosphor layer with good efficiency, which enhances emission performance.

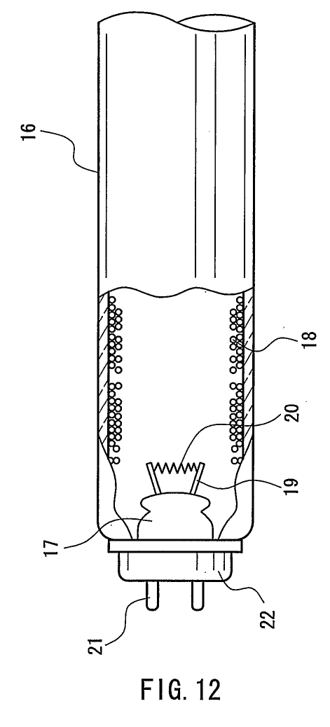

FIG. 12 is a partially cut-away view of an end portion of a fluorescent lamp using the oxynitride phosphor of Embodiment 1 as an exemplary light-emitting device of the present invention.

In FIG. 12, a glass tube 16 is sealed at both end portions with stems 17, and noble gas such as neon, argon, or krypton and mercury are sealed in the glass tube 16. The inner surface of the glass tube 16 is coated with a phosphor 18 containing at least the above-mentioned oxynitride phosphor. A filament electrode 20 is attached to the stem 17 with two leads 19. A cap 22 provided with an electrode terminal 21 is attached to the respective end portions of the glass tube 16, whereby the electrode terminal 21 is connected to the leads 19.

The shape, size, and wattage of the fluorescent lamp of the present embodiment, and the color and color rendering property of light emitted by the fluorescent lamp, and the like are not particularly limited. The shape of the fluorescent lamp of the present embodiment is not limited to a straight tube as shown in FIG. 12. Examples of the shape of the fluorescent lamp include a round shape, a double annular shape, a twin shape, a compact shape, a U-shape, and a bulb shape, and a narrow tube for a liquid crystal backlight and the like also may be used. Examples of the size include 4-type to 110-type. The wattage may be selected appropriately in accordance with the application from a range of several watts to hundreds of watts. Examples of light color include daylight color, neutral white color, white color, and warm white color.

If the oxynitride phosphor activated with Eu²⁺ described in Embodiment 1, which is chemically stable, contains a large amount of red light-emitting component, and has a high emission intensity, is used, the fluorescent lamp in the present embodiment has a higher emission intensity of a red light-emitting component and has less change with time such as degradation, compared with the conventional fluorescent lamp.

Furthermore, the fluorescent lamp also can be configured using an oxynitride phosphor having satisfactory temperature characteristics, so that the fluorescent lamp has a high luminous flux and a higher brightness. More specifically, even when the phosphor is exposed to the temperature condition of 80° C. to 200° C. (in particular, 100° C. to 180° C.), the temperature extinction is small, so that the fluorescent lamp has a high luminous flux or a high brightness. Furthermore, the fluorescent lamp also can be configured using the oxynitride phosphor produced by the production method that costs less, so that an inexpensive light-emitting device can be provided.

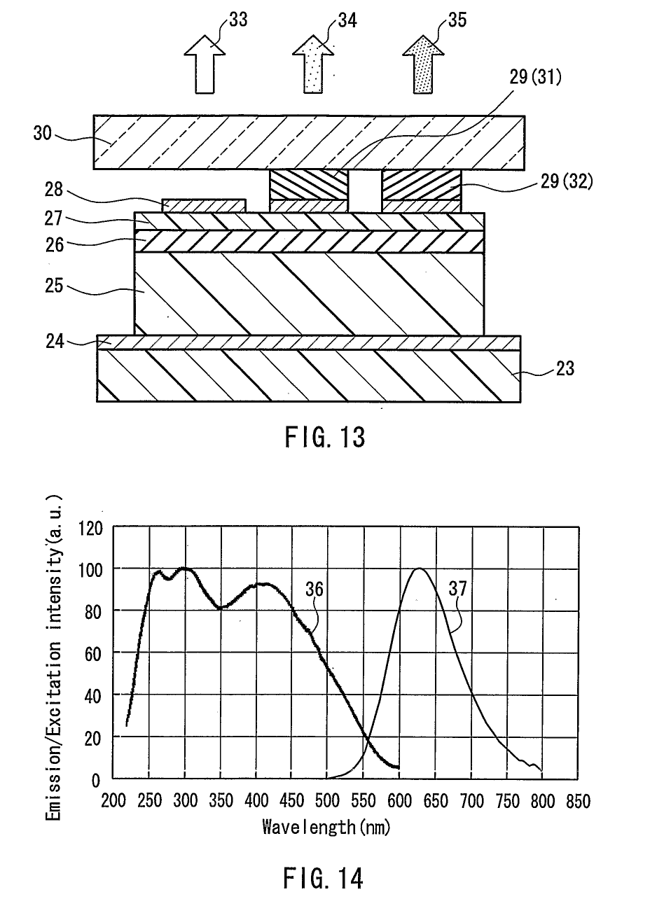

FIG. 13 is a cross-sectional view of a double insulating configuration thin film EL panel, which is an exemplary light-emitting device using the oxynitride phosphor of Embodiment 1.

In FIG. 13, a back substrate 23 holds a thin film EL panel, and is formed of metal, glass, ceramic, or the like. A lower electrode 24 applies an AC voltage of about 100 to 300 V to a laminated configuration of a thick film dielectric 25/thin film phosphor 26/thin film dielectric 27, and is a metal electrode or an In—Sn—O transparent electrode formed by a procedure such as a printing technique. The thick film dielectric 25 functions as a film-formation substrate of the thin film phosphor 26, and also limits the amount of charge flowing through the thin film phosphor 26 during the application of the AC voltage. For example, the thick film dielectric 25 is made of a ceramic material such as BaTiO₃ with a thickness of 10 μm to several cm. Furthermore, the thin film phosphor 26 is made of an EL material that emits fluorescence with high brightness when charge flows through the phosphor layer. The thin film phosphor 26 is, for example, a thioaluminate phosphor (e.g., a BaAl₂S₄:Eu²⁺ blue phosphor, a (Ba, Mg)Al₂S₄:Eu²⁺ blue phosphor, etc.), a thiogallate phosphor (e.g., a CaGa₂S₄:Ce³⁺ blue phosphor, etc.), or the like formed into a film by a thin film technique such as an electron beam vapor evaporation or sputtering. The thin film dielectric 27 limits the amount of charge flowing through the thin film phosphor 26, and prevents the thin film phosphor 26 from reacting with water vapor in the atmosphere to be degraded. The thin film dielectric 27 is, for example, a translucent dielectric such as silicon oxide or aluminum oxide, formed into a film by a thin film technique such as chemical vapor deposition or sputtering. An upper electrode 28 is paired with the lower electrode 24, and applies an AC voltage to the thick film dielectric 25, the thin film phosphor 26, and the thin film dielectric 27. The upper electrode 28 is, for example, a transparent electrode made of In—Sn—O or the like formed on the upper surface of the thin film dielectric 27 by a thin film technique such as vacuum deposition or sputtering. Alight wavelength converting layer 29 converts light (e.g., blue light, etc.) emitted by the thin film phosphor 26 and passing through the thin film dielectric 27 and the upper electrode 28 into, for example, green light, yellow light, or red light. The light wavelength converting layer 29 also can be provided in a plurality of kinds. A surface glass 30 protects the double insulating configuration thin film EL panel thus configured.

When an AC voltage of about 100 to 300 V is applied between the lower electrode 24 and the upper electrode 28 of the thin film EL panel, a voltage of about 100 to 300 V is applied to the thick film dielectric 25, the thin film phosphor 26, and the thin film dielectric 27, and charge flows through the thin film phosphor 26, whereby the thin film phosphor 26 emits light. This emitted light passes through the thin film dielectric 27 and the upper electrode 28 having translucency to have its wavelength converted by the light wavelength converting layer 29, thereby emitting light. The light with its wavelength converted passes through the surface glass 30 and is output from the panel.

In the double insulating configuration thin film EL panel of the present embodiment, at least one light wavelength converting layer 29 is configured using the oxynitride phosphor of Embodiment 1. Furthermore, it is preferable that the thin film phosphor 26 is a thin film blue phosphor emitting blue light, and the light wavelength converting layer 29 is composed of a light wavelength converting layer 31 for converting light into green light, made of a green light-emitting material (e.g., a SrGa₂S₄:Eu²⁺ green phosphor, etc.), and a light wavelength converting layer 32 for converting light into red light, made of the oxynitride phosphors of Embodiment 1 emitting red light, and a part of blue light emitted by the above-mentioned thin film blue phosphor is output from the panel as it is. It is more preferable that the configuration of an electrode is set to be a lattice shape that can be driven in a matrix. When the light-emitting device is designed so as to emit blue light 33 emitted by the thin film phosphor 26, green light 34 with its wavelength converted by the light wavelength converting layer 31, and red light 35 with its wavelength converted by the light wavelength converting layer 32, a thin film EL panel emitting light of three primary colors (blue, green, and red) can be provided. Furthermore, if the lighting of respective pixels in a matrix emitting light of blue, green, and red is allowed to be controlled independently, a display device capable of performing a full-color display can be provided.

In the double insulating configuration thin film EL panel of the present embodiment, if a part of the light wavelength converting layer 29 is configured using the oxynitride phosphor activated with Eu²⁺ described in Embodiment 1 that is stable chemically and emits light containing a large amount of red light-emitting component and having a high emission intensity, a double insulating configuration thin film EL panel having red pixels emitting satisfactory red light and being highly reliable can be provided.

Furthermore, a double insulating configuration thin film EL panel also can be configured using an oxynitride phosphor having satisfactory temperature characteristics, so that an EL panel with a high brightness is obtained. More specifically, even when the phosphor is exposed to the temperature condition of 80° C. to 200° C. (in particular, 100° C. to 180° C.), the temperature extinction is small, so that a double insulating configuration thin film EL panel with a high brightness is obtained. Furthermore, a double insulating configuration thin film EL panel also can be configured using an oxynitride phosphor produced by a production method that cost less, so that an inexpensive EL panel can be provided. Above all, it is preferable to configure a double insulating configuration thin film EL panel in which the above-mentioned thin film phosphor 26 is in contact with the phosphor layer containing an oxynitride phosphor having satisfactory temperature characteristics, because light emitted by the thin film phosphor 26 can be irradiated to a phosphor layer with good efficiency, which enhances emission performance.

Hereinafter, the present invention will be described specifically by way of examples. The present invention is not to be limited by the following examples.

### EXAMPLE 1

As an oxynitride phosphor of Example 1 of the present invention, an oxynitride phosphor substantially having a composition of 0.25(Sr_{0.98}Eu_{0.02})₂Si₅N₈.0.75(Sr_{0.98}Eu_{0.02})₂Si₄AlON₇ was produced using a nitride direction reaction method as follows.

In the present example, the following compounds (1) to (5) were used as phosphor ingredients.

(1) Strontium nitride powder (Sr₃N₂: purity 99.5%): 10.00 g

(2) Europium oxide powder (Eu₂O₃: purity 99.9%): 0.37 g

(3) Silicon nitride powder (Si₃N₄: purity 99%): 10.46 g

(4) Aluminum nitride powder (AlN: purity 99.9%): 0.54 g

(5) Aluminum oxide powder (Al₂O₃: purity 99.99%): 1.34 g

These phosphor ingredients were weighed in a nitrogen atmosphere using a glove box, and then manually mixed thoroughly with a mortar and a pestle. After this, the mixed powder was placed in an alumina crucible. The alumina crucible was placed at a predetermined position in an atmospheric furnace, and heated in nitrogen-hydrogen mixed gas (97% nitrogen and 3% hydrogen) at 1600° C. for 2 hours. As the aftertreatments such as pulverizing, classification, and washing, a general method was used, although the descriptions thereof are omitted herein for simplicity. Hereinafter, the characteristics of the fired product obtained by the above-mentioned production method will be described.

The body color of the oxynitride phosphor of Example 1 was vibrant orange. FIG. 14 shows an excitation spectrum 36 of the fired product obtained by the above production method, and an emission spectrum 37 when excited with light having a wavelength of 254 nm. FIG. 14 shows that the above-mentioned fired product is a red phosphor having an emission peak in the vicinity of a wavelength of 626 nm, which is excited with light in a wavelength range of 220 nm to 600 nm (i.e., ultraviolet—near-ultraviolet—violet—blue—green—yellow—orange light). The chromaticity (x, y) of emitted light in a CIE chromaticity coordinate was x=0.609 and y=0.386.

Constituent elements of the above-mentioned fired product were evaluated by semiquantitative analysis using an X-ray microanalyzer (XMA), a fluorescent X-ray analysis apparatus, a spectrochemical analysis apparatus, or the like. Consequently, the fired product was found to be a compound mainly containing Sr, Si, Al, O, and N.

Then, the constituent metal elements of the above fired product were evaluated by quantitative analysis using an ICP emission spectrochemical analysis method. Consequently, the ratio of the above constituent metal elements Sr:Eu:Si:Al was about 1.96:0.04:4.25:0.75, which was substantially the same as a charged composition.

Furthermore, the crystal structure of the above fired product was evaluated using the X-ray diffraction method. Consequently, an X-ray diffraction pattern similar to those of the conventional Sr₂Si₅N₈:Eu²⁺ nitride phosphor and Sr₂Si₄AlON₇:Eu²⁺ was exhibited.

It was found from the above that the oxynitride phosphor of the present example was a phosphor having a single crystal phase represented by 0.25(Sr_{0.98}Eu_{0.02})₂Si₅N₈.0.75(Sr_{0.98}Eu_{0.02})₂Si₄AlON₇. More specifically, it was found that the oxynitride phosphor represented by (Sr, Eu)₂Si_{4.25}Al_{0.75}O_{0.75}N_{7.25} was produced by the above production method.

### EXAMPLES 2, 3 AND COMPARATIVE EXAMPLES 2, 3

Hereinafter, as oxynitride phosphors of Examples 2 and 3 of the present invention, oxynitride phosphors, substantially having a composition of (1−x)(Sr_{0.98}Eu_{0.02})Si₅N₈.x(Sr_{0.98}Eu_{0.02})₂Si₄AlON₇, where x is 0.5 (Example 2) and 0.25 (Example 3), were produced as follows. Furthermore, as phosphors of Comparative Examples 1 and 2, phosphors, substantially having a composition of (1−x)(Sr_{0.98}Eu_{0.02})₂Si₅N₈.x(Sr_{0.98}Eu_{0.02})₂Si₄AlON₇, where x is 1 and 0, were produced as follows. More specifically, the phosphor of Comparative Example (x=1) was a conventional Sr₂Si₄AlON₇:Eu²⁺ oxynitride phosphor, and the phosphor of Comparative Example (x=0) was a conventional Sr₂Si₅N₈:Eu²⁺ nitride phosphor.

The oxynitride phosphors of the present examples and comparative examples were produced by the same method and under the same condition as those of the oxynitride phosphor (x=0.75) of Example 1, except that the above phosphor ingredients (1) to (5) were used in weight ratios shown in Table 1.

TABLE 1

| | Sr₃N₂(g) | Eu₂O₃(g) | Si₃N₄(g) | AlN(g) | Al₂O₃(g) |
|---|---|---|---|---|---|
| Comparative | 10.00 | 0.37 | 12.30 | 0 | 0 |
| Example 2 | | | | | |
| (x = 0) | | | | | |
| Example 3 | 10.00 | 0.37 | 11.69 | 0.18 | 0.45 |
| (x = 0.25) | | | | | |
| Example 2 | 10.00 | 0.37 | 11.07 | 0.36 | 0.90 |
| (x = 0.5) | | | | | |
| Example 1 | 10.00 | 0.37 | 10.46 | 0.54 | 1.34 |
| (x = 0.75) | | | | | |
| Comparative | 10.00 | 0.37 | 9.84 | 0.72 | 1.79 |
| Example 1 | | | | | |
| (x = 1) | | | | | |

Hereinafter, the characteristics of the phosphors of Examples 1-3 and Comparative Examples 1, 2 obtained by the above-mentioned production method will be described.

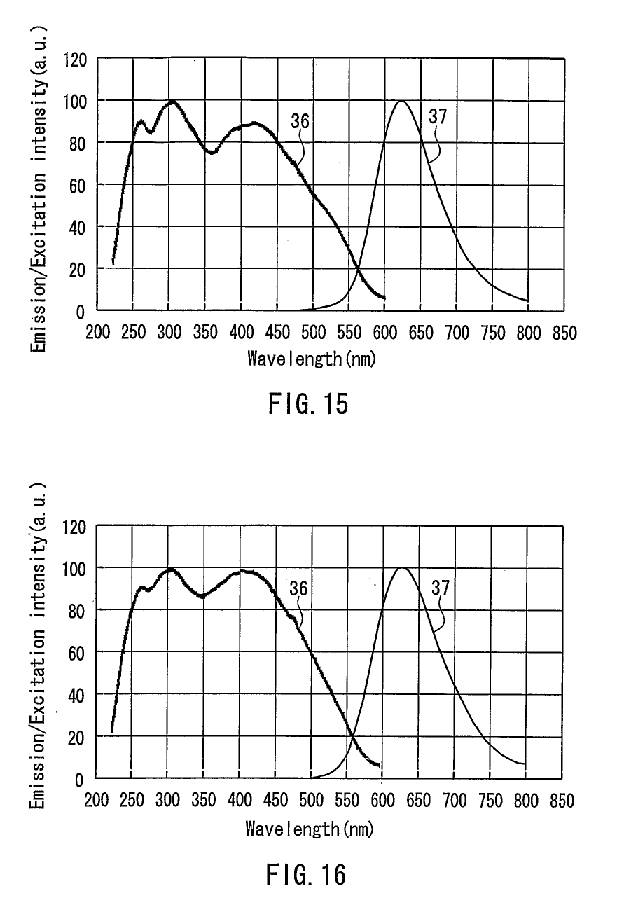

The body colors of the phosphors of Examples 1-3 and Comparative Examples 1, 2 were orange. Furthermore, the excitation spectrum and emission spectrum of the phosphors of Examples 1-3 (see FIG. 14 regarding the spectrum of Example 1) were similar to those of Comparative Examples 1 and 2. For reference, FIGS. 15 and 16 show excitation spectra and emission spectra of the phosphors of Comparative Examples 1 and 2.

Table 2 shows a wavelength and chromaticity of an emission peak when the phosphors of Examples 1-3, and Comparative Examples 1 and 2 obtained by the above-mentioned production method were excited with ultraviolet light having a wavelength of 254 nm, and a wavelength of an emission peak when these phosphors were excited with blue light having a wavelength of 470 nm. Measurement was conducted at a phosphor temperature of 25° C. (room temperature).

TABLE 2

| | | | Under excitation of |
|---|---|---|---|
| | Under excitation of 254 nm | | 470 nm |
| | Wavelength of | | Wavelength of |
| X | emission peak (nm) | Chromaticity (x, y) | emission peak (nm) |
| 0 | 624 | (0.6125, 0.3824) | 621 |
| 0.25 | 623 | (0.6150, 0.3808) | 622 |
| 0.50 | 623 | (0.6116, 0.3829) | 629 |
| 0.75 | 626 | (0.6088, 0.3855) | 629 |
| 1.00 | 630 | (0.6065, 0.3869) | 632 |

It is understood from Table 2 that these phosphors are red phosphors having an emission peak in the vicinity of a wavelength of 625 nm irrespective of the above numerical value of x, when excited with ultraviolet light having a wavelength of 254 nm. It also is understood that, when excited with blue light having a wavelength of 470 nm, as the above numerical value of x increases, these phosphors become red phosphors whose wavelength of an emission peak shifts in a long wavelength direction and which emit dark red light. More specifically, these phosphors can be adjusted finely for the spectral luminous efficacy of red light by controlling the numerical value of x. As is understood from Table 2, this is because the emission color can be controlled when excited with blue light by controlling the numerical value of x.

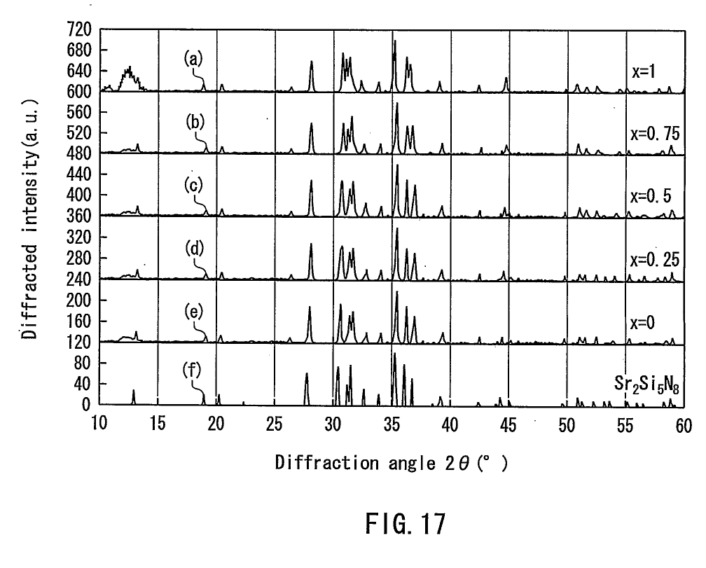

FIG. 17 shows X-ray diffraction patterns of the phosphors of Examples 1-3, and Comparative Examples 1 and 2, and an X-ray diffraction pattern of a Sr₂Si₅N₈ compound obtained by simulation from a crystal structure using a Rietveld analysis program.

In FIG. 17, (a), (b), (c), (d), (e), and (f) represent X-ray diffraction patterns of Comparative Example 1, Examples 1-3, Comparative Example 2, and the X-ray diffraction pattern of the Sr₂Si₅N₈ compound obtained by the above simulation.

It is understood from FIG. 17 that the X-ray diffraction patterns of the phosphors in which the above-mentioned x varies have similar basic shapes. It also is understood that, as the numerical value of x is larger, a majority of the respective diffraction peaks shifts on a low angle side. Furthermore, the crystal structure of the conventional Sr₂Si₄AlON₇ compound has not been known well; however, it was clarified that the conventional Sr₂Si₄AlON₇ compound has at least the same orthorhombic crystal structure as that of the known nitrides Sr₂Si₅N₈ and Ba₂Si₅N₈.

The X-ray diffraction pattern of the above Sr₂Si₅N₈ compound is obtained by calculation using crystal parameters described in Document 8 and atomic coordinates. For reference, Table 3 shows a d-value of each hkl plane of the Sr₂Si₅N₈ compound obtained by calculation using the crystal parameters described in Document 8 and atomic coordinates, a relative X-ray diffracted intensity in the case of evaluating X-ray diffraction using a Cu-Kα ray, and a diffraction angle (2θ).

TABLE 3

| | | Relative | | | |
|---|---|---|---|---|---|
| 2θ | d value | intensity | | | |
| (°) | (Å) | (a.u.) | h | k | 1 |
| 12.966 | 6.822 | 26 | 0 | 1 | 0 |
| 16.075 | 5.509 | 1 | 0 | 1 | 1 |
| 18.194 | 4.872 | 1 | 1 | 0 | 1 |
| 18.986 | 4.671 | 18 | 0 | 0 | 2 |
| 20.264 | 4.379 | 18 | 1 | 1 | 0 |
| 22.406 | 3.965 | 5 | 1 | 1 | 1 |
| 23.059 | 3.854 | 1 | 0 | 1 | 2 |
| 26.103 | 3.411 | 5 | 0 | 2 | 0 |
| 27.821 | 3.204 | 61 | 0 | 2 | 1 |
| 27.907 | 3.194 | 44 | 1 | 1 | 2 |
| 30.502 | 2.928 | 73 | 1 | 2 | 0 |
| 31.305 | 2.855 | 41 | 2 | 0 | 0 |
| 31.559 | 2.833 | 79 | 0 | 1 | 3 |
| 32.004 | 2.794 | 2 | 1 | 2 | 1 |
| 32.477 | 2.755 | 1 | 0 | 2 | 2 |
| 32.733 | 2.734 | 31 | 1 | 0 | 3 |
| 34.012 | 2.634 | 22 | 2 | 1 | 0 |
| 35.343 | 2.538 | 100 | 1 | 1 | 3 |
| 35.381 | 2.535 | 100 | 2 | 1 | 1 |
| 36.176 | 2.481 | 78 | 1 | 2 | 2 |
| 36.868 | 2.436 | 52 | 2 | 0 | 2 |
| 38.519 | 2.335 | 6 | 0 | 0 | 4 |
| 39.140 | 2.300 | 17 | 0 | 2 | 3 |
| 39.239 | 2.294 | 13 | 2 | 1 | 2 |
| 39.600 | 2.274 | 3 | 0 | 3 | 0 |
| 40.807 | 2.209 | 4 | 0 | 3 | 1 |
| 40.808 | 2.209 | 4 | 0 | 1 | 4 |
| 41.199 | 2.189 | 2 | 2 | 2 | 0 |
| 42.336 | 2.133 | 7 | 1 | 2 | 3 |
| 42.369 | 2.132 | 9 | 2 | 2 | 1 |
| 42.767 | 2.113 | 2 | 1 | 3 | 0 |
| 43.902 | 2.061 | 5 | 1 | 3 | 1 |
| 43.904 | 2.061 | 5 | 1 | 1 | 4 |
| 44.265 | 2.045 | 17 | 0 | 3 | 2 |
| 45.048 | 2.011 | 10 | 2 | 1 | 3 |
| 45.731 | 1.982 | 3 | 2 | 2 | 2 |
| 47.125 | 1.927 | 1 | 0 | 2 | 4 |
| 47.178 | 1.925 | 4 | 1 | 3 | 2 |
| 48.789 | 1.865 | 0 | 3 | 0 | 1 |
| 49.600 | 1.836 | 7 | 0 | 3 | 3 |
| 49.689 | 1.833 | 5 | 3 | 1 | 0 |
| 49.908 | 1.826 | 1 | 1 | 2 | 4 |
| 50.445 | 1.808 | 1 | 2 | 0 | 4 |
| 50.617 | 1.802 | 4 | 0 | 1 | 5 |
| 50.703 | 1.799 | 3 | 3 | 1 | 1 |
| 50.948 | 1.791 | 19 | 2 | 2 | 3 |
| 51.323 | 1.779 | 12 | 2 | 3 | 0 |
| 51.420 | 1.776 | 7 | 1 | 0 | 5 |
| 52.286 | 1.748 | 11 | 1 | 3 | 3 |
| 52.314 | 1.747 | 6 | 2 | 3 | 1 |
| 52.315 | 1.747 | 6 | 2 | 1 | 4 |
| 53.266 | 1.718 | 10 | 1 | 1 | 5 |
| 53.663 | 1.707 | 12 | 3 | 1 | 2 |
| 53.699 | 1.706 | 6 | 0 | 4 | 0 |
| 54.660 | 1.678 | 1 | 0 | 4 | 1 |
| 55.213 | 1.662 | 12 | 2 | 3 | 2 |
| 55.219 | 1.662 | 12 | 3 | 2 | 0 |
| 56.082 | 1.639 | 8 | 0 | 2 | 5 |
| 56.162 | 1.636 | 2 | 3 | 2 | 1 |
| 56.245 | 1.634 | 4 | 1 | 4 | 0 |
| 56.433 | 1.629 | 4 | 0 | 3 | 4 |
| 56.631 | 1.624 | 7 | 3 | 0 | 3 |
| 57.178 | 1.610 | 2 | 1 | 4 | 1 |
| 57.477 | 1.602 | 3 | 0 | 4 | 2 |
| 57.668 | 1.597 | 4 | 2 | 2 | 4 |
| 58.363 | 1.580 | 13 | 3 | 1 | 3 |
| 58.560 | 1.575 | 7 | 1 | 2 | 5 |
| 58.901 | 1.567 | 13 | 1 | 3 | 4 |
| 58.933 | 1.566 | 17 | 3 | 2 | 2 |
| 59.310 | 1.557 | 7 | 0 | 0 | 6 |
| 59.832 | 1.544 | 7 | 2 | 3 | 3 |
| 59.918 | 1.542 | 4 | 1 | 4 | 2 |

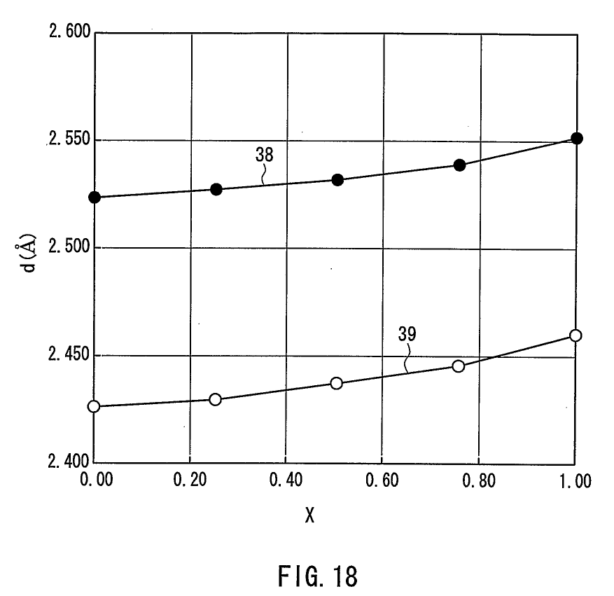

FIG. 18 shows the dependence of a d-value of each crystal plane with respect to the above-mentioned x, the d-value being calculated from 20 under the condition of picking up a main diffraction peak 38 (mixed diffraction peak where (hkl) is (113) and (211)) in which 2θ is positioned in the vicinity of 35° to 36° and a diffraction peak 39 (diffraction peak where (hkl) is (202)) having a large change amount of 2θ involved in the above-mentioned x in which 2θ is positioned in the vicinity of 36.5° to 37.5°, as representative diffraction peaks.

It is understood from FIG. 18 that the above-mentioned d-value increases with an increase in x.

The results shown in FIGS. 17 and 18 show that the oxynitride phosphors of Examples 1 to 3 can form a solid solution having a single crystal phase, i.e., can produce an oxynitride phosphor represented by a chemical formula: (1−x)(Sr_{0.98}Eu_{0.02})₂Si₅N₈.x(Sr_{0.98}Eu_{0.02})₂Si₄AlON₇ containing Eu²⁺ in a luminescent center ion.

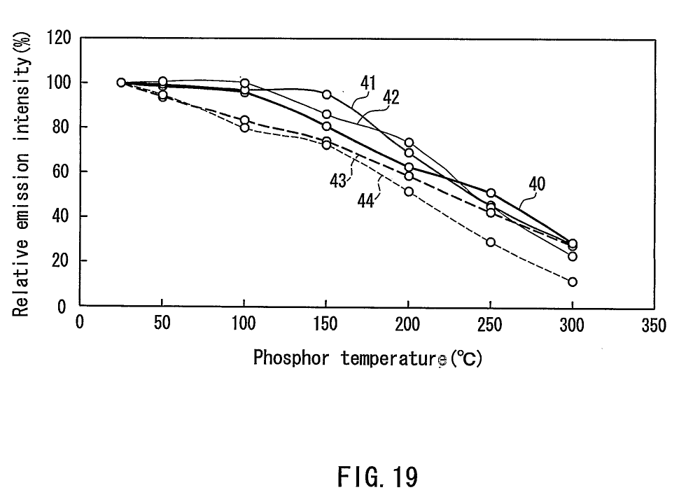

FIG. 19 shows a change in a relative emission intensity (intensity of an emission peak) depending upon a phosphor temperature with respect to the phosphors of Examples 1 to 3 and Comparative Examples 1 and 2. Furthermore, Table 4 summarizes a relative emission intensity at a phosphor temperature of 100° C., 150° C., and 200° C. with respect to each phosphor. Herein, the relative emission intensity refers to an emission intensity of each phosphor temperature with the emission intensity of a phosphor excited with light having a wavelength of 470 nm at room temperature (25° C.) being 100%.

In FIG. 19, the relative emission intensities 40, 41, 42, 43, and 44 respectively are those of the phosphors of Comparative Example 2 (×0), Example 3 (x=0.25), Example 2 (x=0.5), Example 1 (x=0.75), and Comparative Example 1 (x=1).

TABLE 4

| | Relative emission intensity (%) | | |
|---|---|---|---|
| x | 100° C. | 150° C. | 200° C. |
| 0 | 96.1 | 80.9 | 62.8 |
| 0.25 | 97.1 | 95.3 | 69.1 |
| 0.50 | 100.4 | 86.3 | 73.7 |
| 0.75 | 83.5 | 74.1 | 58.9 |
| 1.00 | 79.9 | 72.4 | 51.9 |

It is understood from FIG. 19 and Table 4 that, in the case where the numerical value of x is in a range of 0≦x≦0.75 (0≦x≦0.75, when Comparative Example 2 that is a conventionally known phosphor is excluded) at a phosphor temperature of 100° C., temperature characteristics more satisfactory than those of the phosphor of Comparative Example 1 are obtained. Furthermore, in the case of considering the use at a phosphor temperature of 100° C., the emission intensity of 80% or more at room temperature is maintained when 0≦x≦0.8 (0≦x≦0.8 when Comparative Example 2 that is a conventionally known phosphor is excluded). Thus, the above-mentioned range is understood to be preferable.

As a composition of a phosphor that is clearly different from that of the phosphor of Comparative Example 2, preferable x is considered to be a numerical value in a range of 0.1≦x≦0.8, in particular, 0.2≦x≦0.8. Furthermore, it is considered from FIG. 19 and Table 4 that more preferable x is in a range of 0.1≦x≦0.6, in particular, 0.2≦x≦0.6. In this numerical value range, temperature characteristics more satisfactory than those of the phosphor of Comparative Example 2 having satisfactory temperature characteristics are obtained.

### EXAMPLES 4-10

As the oxynitride phosphors of Examples 4 to 10 of the present invention, an oxynitride phosphor substantially having a composition of 0.5(M′_{0.98}Eu_{0.02})₂Si₅N₈.0.5(M′_{0.98}Eu_{0.02})₂Si₄AlON₇ was produced using carbothermal reduction-nitridation different from that of Examples 1 to 3 as follows. The above-mentioned M′ is at least one alkaline earth metal element selected from Sir, Ba, and Ca, and its composition ratio is shown in Table 5.

In the oxynitride phosphor of the present example, the following phosphor ingredients (1) to (6), and a reducing agent (7) were used in a weight ratio shown in Table 5.
(1) Calcium carbonate powder (CaCO₃: purity 99.99%)
(2) Strontium carbonate powder (SrCO₃: purity 99.9%)
(3) Barium carbonate powder (BaCO₂: purity 99.95%)
(4) Europium oxide powder (Eu₂O₃: purity 99.9%)
(5) Silicon nitride powder (Si₃N₄: purity 99.9%)
(6) Aluminum nitride powder (AIN: purity 99.9%)

(7) Carbon powder (C: purity 99.99%)

TABLE 5

| | CaCO₃ | SrCO₃ | BaCO₃ | Eu₂O₃ | Si₃N₄ | AlN | C |
|---|---|---|---|---|---|---|---|
| | (g) | (g) | (g) | (g) | (g) | (g) | (g) |
| Example 4 | 0 | 14.468 | 0 | 0.352 | 10.522 | 1.025 | 0.991 |
| (M′ = Sr) | | | | | | | |
| Example 5 | 0 | 11.515 | 3.947 | 0.352 | 10.522 | 1.025 | 0.991 |
| (M′ = Sr_{0.8}Ba_{0.2}) | | | | | | | |
| Example 6 | 0 | 8.562 | 7.894 | 0.352 | 10.522 | 1.025 | 0.991 |
| (M′ = Sr_{0.6}Ba_{0.4}) | | | | | | | |
| Example 7 | 0 | 5.610 | 11.841 | 0.352 | 10.522 | 1.025 | 0.991 |
| (M′ = Sr_{0.4}Ba_{0.6}) | | | | | | | |
| Example 8 | 2.002 | 11.515 | 0 | 0.352 | 10.522 | 1.025 | 0.991 |
| (M′ = Sr_{0.8}Ca_{0.2}) | | | | | | | |
| Example 9 | 4.004 | 8.562 | 0 | 0.352 | 10.522 | 1.025 | 0.991 |
| (M′ = Sr_{0.6}Ca_{0.4}) | | | | | | | |
| Example 10 | 6.005 | 5.610 | 0 | 0.352 | 10.522 | 1.025 | 0.991 |
| (M′ = Sr_{0.4}Ca_{0.6}) | | | | | | | |

These phosphor ingredients and the reducing agent were weighed in an atmosphere, and then mixed thoroughly with an automatic mortar. After this, the mixed powder was placed in a carbon crucible. The carbon crucible was placed at a predetermined position in an atmospheric furnace, and heated in nitrogen-hydrogen mixed gas (97% nitrogen and 3% hydrogen) at 1600° C. for 2 hours. As the aftertreatments such as pulverizing, classification, and washing, a general method was used, although they are omitted herein for simplicity

Hereinafter, the characteristics of the phosphors of Examples 4 to 10 obtained by the above-mentioned production method will be described.

The body colors of the oxynitride phosphors were orange. According to crystal structure evaluation by an X-ray diffraction method, each of the oxynitride phosphors was a single crystal phase or close thereto, and exhibited an X-ray diffraction pattern similar to that of the above-mentioned 0.5Sr₂Si₅N₈.0.5Sr₂Si₄AlON₇:Eu²⁺ oxynitride phosphor.

Each of the above-mentioned oxynitride phosphors was a red phosphor having an emission peak in the vicinity of a wavelength of 614 to 640 nm, capable of being excited with light in a wide wavelength range of 220 to 600 nm. Furthermore, with the wavelength of 621 nm of an emission peak of the phosphor (Example 4) in which all the M′ is Sr being the base, as a Ba replacement amount is larger, an emission peak shifts to a short wavelength side, and as a Ca replacement amount is larger, an emission peak shifted to a long wavelength side. In the case where the ratio of Sr in M′ became a half or less, an emission intensity decreased, and a different phase was recognized to be mixed.

The above-mentioned oxynitride phosphor was a compound containing alkaline earth metal M′, Si, Al, O, and N as main constituent elements, and the ratio of the constituent elements of the phosphor (Alkaline earth metal M′:Eu:Si:Al) was 1.96:0.04:4.5:0.5. Thus, the composition was substantially the same as the charged composition.

It is understood from these results that, according to the production methods of Examples 4 to 10, a phosphor having a single crystal phase represented by 0.5 (M_{0.98}Eu_{0.02})₂Si₅N₈.0.5(M′_{0.98}Eu_{0.02})₂Si₄AlON₇, i.e., an oxynitride phosphor represented by a chemical formula: (M′_{0.98}Eu_{0.02})₂Si_{4.5}Al_{0.5}O_{0.5}N_{7.5} was produced, especially in the case where the ratio of Sr in M′ occupied a majority.

Phosphors where the above-mentioned M′ is Sr_{0.2}Ba_{0.8}, Ba, Sr_{0.2}Ca_{0.8} and Ca also were investigated; however, emission was hardly recognized in these phosphors.

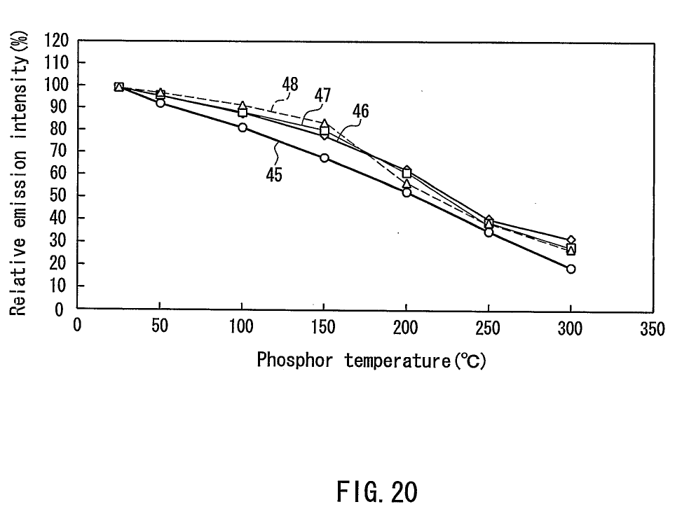

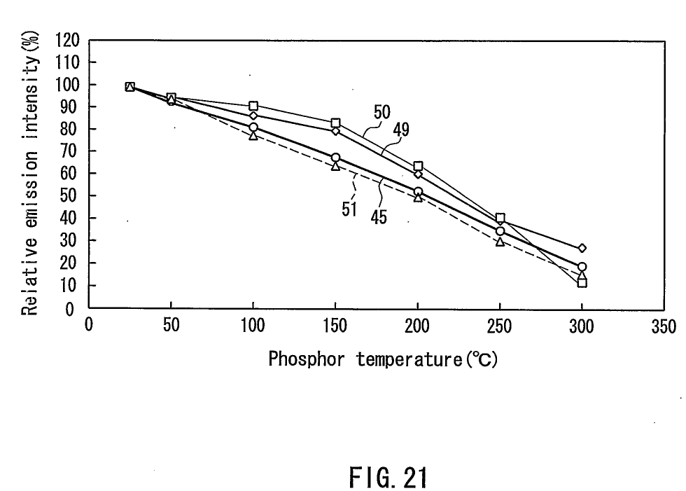

FIGS. 20 and 21 show a change in a relative emission intensity (intensity of an emission peak) depending upon a phosphor temperature with respect to Examples 4 to 10. Table 6 summarizes a relative emission intensity at a phosphor temperature of 100° C., 150° C., and 200° C. with respect to each phosphor. Herein, the relative emission intensity refers to an emission intensity at each phosphor temperature with the emission intensity at room temperature (25° C.) of a phosphor excited with light having a wavelength of 470 nm being 100%.

In FIG. 20, the relative emission intensities 45, 46, 47, and 48 respectively are those of phosphors of Examples 4, 5, 6, and 7. Furthermore, in FIG. 21, the relative emission intensities 45, 49, 50, and 51 are those of the phosphors of Examples 4, 8, 9, and 10.

TABLE 6

| | Relative emission intensity (%) | | |
|---|---|---|---|
| | 100° C. | 150° C. | 200° C. |
| Example 4 | 81.5 | 67.8 | 52.5 |
| (M′ = Sr) | | | |
| Example 5 | 88.0 | 78.1 | 62.7 |
| (M′ = Sr_{0.8}Ba_{0.2}) | | | |
| Example 6 | 89.0 | 81.0 | 61.0 |
| (M′ = Sr_{0.6}Ba_{0.4}) | | | |
| Example 7 | 91.9 | 84.0 | 56.8 |
| (M′ = Sr_{0.4}Ba_{0.6}) | | | |
| Example 8 | 86.5 | 80.0 | 59.8 |
| (M′ = Sr_{0.8}Ca_{0.2}) | | | |
| Example 9 | 91.0 | 83.5 | 64.0 |
| (M′ = Sr_{0.6}Ca_{0.4}) | | | |
| Example 10 | 78.0 | 64.0 | 50.0 |
| (M′ = Sr_{0.4}Ca_{0.6}) | | | |

The following is understood from FIGS. 20, 21, and Table 6. Regarding the phosphors (Examples 5, 6, and 7) in which the replacement amount of Ba with respect to Sr, as a Ba replacement amount was larger, the temperature extinction in a phosphor temperature range of 100° C. to 200° C. was improved, compared with the phosphor (Example 4) containing no Ba. Furthermore, regarding the phosphors (Examples 8 and 9) in which the replacement amount of Ca with respect to Sr was 40 atomic % or less, as a Ca replacement amount was larger, the temperature extinction in a phosphor temperature range of 100° C. to 200° C. was improved, compared with the phosphor (Example 4) containing no Ca.

In the case where Sr²⁺ ions were replaced by Ca²⁺ ions having a radius smaller than that of the Sr²⁺ ions, it was recognized that the temperature extinction of the phosphor activated with Eu²⁺ was improved. It is understood from Examples 4 to 10 that, in the case where the above-mentioned M′ is composed of at least one element selected from Sr, Ca, and Ba, M′ contains Sr mainly, and in the case where M′ contains at least one selected from Ca and Ba (preferably Ba) in an amount where the replacement amount with respect to Sr is less than 50 atomic %, preferably 40 atomic % or less, the temperature extinction was recognized to be improved.

The temperature characteristics of Example 4 containing no Ca and Ba were slightly worse than those of Example 2 (oxynitride phosphor synthesized by a nitride direct reaction method). This is considered to be ascribed to the fact that the quality of an oxynitride phosphor varied depending upon the difference in a production method of a phosphor. It is considered that the quality and temperature characteristics of a phosphor can be improved by optimizing future production conditions even by the carbothermal reduction-nitridation.

Furthermore, in Examples 4 to 10, the phosphors in which the above-mentioned M′ is composed of Ca, Sr, and Ba have been described. However, the above-mentioned M′ can be composed of Mg, Ca, Sr, Ba, and Zn, and these elements are similar to each other in chemical properties, so that the similar phosphors having similar effects are obtained.

Furthermore, in Examples 4 to 10, an oxynitride phosphor using Eu²⁺ as a luminescent center ion has been described. However, the luminescent center ion can be selected from a wide range such as rare-earth ions and transition metal ions, as described above. Although not described in detail, for example, an oxynitride phosphor using Ce³⁺ as a luminescent center ion becomes a green phosphor with a high efficiency.

Furthermore, although not described in detail, in an oxynitride phosphor represented by the above-mentioned chemical formula: (M, Eu)ₐSi_{b}Al_{c}O_{d}N_{((2/3})a+(4/3)b+c−(2/3)d), M is at least one element selected from Mg, Ca, Sr, Ba, and Zn, and a, b, c, and d are numerical values respectively satisfy expressions: 1.5≦a≦2.5, 4≦b≦6, 0≦c≦2, 0≦d≦2, with a phosphor having a composition range where a, b, c, and d are numerical values satisfying 1.5≦a≦1.9, 5≦b≦6, 1≦c≦2, 1≦d≦2, other than a composition range where the phosphor becomes a solid solution, or having a composition of an apparently large difference between c and d, it was difficult to obtain a phosphor exhibiting high emission performance comparable to those of the above-mentioned conventional M₂Si₅N₈:Eu²⁺ nitride phosphor and Sr₂Si₄AlON₇:Eu²⁺ oxynitride phosphor, i.e., an oxynitride phosphor satisfying both red light radiation having an emission peak in the vicinity of 620 to 640 nm and having satisfactory color purity and spectral luminous efficacy, and high photoluminescence performance (excitation light conversion efficiency).

According to the present invention, it was verified that there exists a compound of single crystal represented by the above-mentioned chemical formula: M₂Si₅₋ₚAlₚOₚN₈₋ₚ and the compound functions as a phosphor host. Thus, needless to say, various oxynitride phosphors can be provided by appropriately selecting and adding a luminescent center ion to a crystal lattice of the compound. According to the present invention, a phosphor containing a compound represented by M₂Si₅₋ₚAlₚOₚN₈₋ₚ as a phosphor host can be provided widely.

The present invention can be carried out in the other embodiments without departing from its spirit. The embodiments disclosed in the present application are shown merely for illustrative purpose, and the present invention is not limited thereto. The scope of the present invention is interpreted by giving high priority to the recitation of the attached claims rather than the above description in the specification, and all the changes within the scope equivalent to that of the claims are included in the scope of the claims.

### INDUSTRIAL APPLICABILITY

As described above, according to the present invention, a novel oxynitride phosphor can be provided, which is produced easily has satisfactory emission characteristics and high emission performance, and is chemically stable. In particular, an oxynitride phosphor emitting red light and having satisfactory temperature characteristics can be provided. Furthermore, a highly reliable light-emitting device using a phosphor composed of a novel material containing the oxynitride phosphor as a light-emitting source, in particular, a light-emitting device having a high intensity of a red light-emitting component can be provided.

1. An oxynitride phosphor comprising a luminescent center ion in a crystal lattice of an oxynitride,
wherein the oxynitride is a compound represented by a chemical formula: M₂Si₅₋ₚAlₚOₚN₈₋ₚ, where M is at least one element selected from the group consisting of Mg, Ca, Sr, Ba, and Zn, and p is a numerical value satisfying an expression: 0<p<1.

2. The oxynitride phosphor according to claim 1, wherein the luminescent center ion is at least one ion selected from Eu²⁺ and Ce³⁺.

3. The oxynitride phosphor according to claim 1, wherein the luminescent center ion is Eu²⁺, the oxynitride phosphor is represented by a chemical formula: (1−x)(M₁₋ₙEuₙ)₂Si₅N₈.x(M₁₋ₙEuₙ)₂Si₄AlON₇, where x is a numerical value satisfying an expression: 0.2≦x≦0.8, and n is a numerical value satisfying an expression 0.001≦n≦0.3.

4. The oxynitride phosphor according to claim 3, wherein the x is a numerical value satisfying an expression: 0.5≦x≦0.8.

5. The oxynitride phosphor according to claim 3, wherein the x is a numerical value satisfying an expression: 0.2≦x≦0.6.

6. The oxynitride phosphor according to claim 1, wherein a main component of the M is Sr.

7. The oxynitride phosphor according to claim 6, further comprising at least one element selected from Ba and Ca.

8. The oxynitride phosphor according to claim 1, produced by carbothermal reduction-nitridation method using carbon as a reducing agent.

9. Alight-emitting device comprising an oxynitride phosphor and an excitation source exciting the oxynitride phosphor,
wherein the oxynitride phosphor contains a luminescent center ion in a crystal lattice of an oxynitride,
the oxynitride is a compound represented by a chemical formula: M₂Si₅₋ₚAlₚOₚN₈₋ₚ, where M is at least one element selected from the group consisting of Mg, Ca, Sr, Ba, and Zn, and p is a numerical value satisfying an expression: 0<p<1.

10. The light-emitting device according to claim 9, wherein the excitation source is a light-emitting element emitting light having an emission peak in a wavelength range of 360 nm to less than 560 nm.

11. The light-emitting device according to claim 10, wherein the light-emitting element is in contact with a phosphor layer containing the oxynitride phosphor.

12. The light-emitting device according to claim 9, emitting white light.

13. The light-emitting device according to claim 9, wherein the luminescent center ion is at least one ion selected from Eu²⁺ and Ce³⁺.

14. The light-emitting device according to claim 9, wherein the luminescent center ion is Eu²⁺, and the oxynitride phosphor is represented by a chemical formula: (1−x)(M₁₋ₙEuₙ)₂Si₅N₈.x(M₁₋ₙEuₙ)₂Si₄AlON₇, where x is a numerical value satisfying air expression: 0.2≦x≦0.8 and n is a numerical value satisfying an expression: 0.001≦n≦0.3.

15. The light-emitting device according to claim 14, wherein the x is a numerical value satisfying an expression: 0.5≦x≦0.8.

16. The light-emitting device according to claim 14, wherein the x is a numerical value satisfying an expression: 0.2≦x≦0.6.

17. The light-emitting device according to claim 9, wherein a main component of the M is Sr.

18. The light-emitting device according to claim 17, wherein the M further contains at least one element selected from Ba and Ca.

19. The light-emitting device according to claim 9, wherein the oxynitride phosphor is produced by carbothermal reduction-nitridation using carbon as a reducing agent.
